(19) United States
(12) Patent Application Publication
(10) Pub. No.: US 2015/0170072 A1
(43) Pub. Date: Jun. 18, 2015

(54) SYSTEMS AND METHODS FOR MANAGING NETWORK RESOURCE REQUESTS

(71) Applicant: AD-VANTAGE NETWORKS, INC., Glendale, CA (US)

(72) Inventors: David S. Grant, Mission Viejo, CA (US); Sanjeev Kuwadekar, Northridge, CA (US); Ravindra Pratap Singh, Anaheim, CA (US)

(21) Appl. No.: 14/339,278

(22) Filed: Jul. 23, 2014

Related U.S. Application Data
(60) Provisional application No. 61/858,890, filed on Jul. 26, 2013.

(51) Int. Cl. G06Q 10/06; H04L 29/06

(52) U.S. Cl. CPC G06Q 10/067; H04L 63/10

(57) ABSTRACT

Systems and methods are configured to control network and content access. A URL rewrite engine receives a content request from a client device coupled to a local network. A first set of rules, the first set of rules comprising a combination of meta rules and content rules, is accessed. The URL rewrite engine applies the first set of rules to the request and/or the requested content to determine how the content request and/or the content are to be processed. Based at least in part on the application of the first set of rules, rewriting the request, denying the request, or modifying the requested content is performed.

### INCORPORATION BY REFERENCE TO ANY PRIORITY APPLICATIONS

Any and all applications for which a foreign or domestic priority claim is identified in the Application Data Sheet as filed with the present application, are hereby incorporated by reference in their entirety under 37 CFR 1.57.

### BACKGROUND OF THE INVENTION

1. Field of the Invention

Embodiments disclosed herein relate to systems and methods for monitoring and controlling network access, such as by premise operators.

2. Description of the Related Art

The Internet has become an essential tool for large numbers of people.

The Internet is used to perform searches, run applications, review content, communicate with others, house emails and files, etc.

With respect to the Internet it has proved to be difficult for users and access providers to manage programming and content. In particular, because the content is now embedded in web pages it makes it difficult for users and access providers to manage the content they see or execute on their devices. For example, the Internet generally does not adequately enable the restriction of certain product placement such as tobacco advertisements in children's programming or the monitoring of produced or real-time streaming content. Further, from the perspective of consumers, the Internet suffers from other deficiencies. Publishers can add tags into their pages that display ads to the highest bidder or install scripts that access potentially private information. Embedded content is also the vehicle typically used to deliver viruses to users such as the Trojan Virus and RootKit virus which can be used to damage a user's finances, breach the user's privacy, and damage the user's connected device.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A system, such as a reference encryption and security translation system (RESTS)/URL rewrite engine, and processes described herein may provide network administrators and access providers with technologies to better manage the security, delivery, content, and/or resources transmitted over networks, including their own networks. Optionally, the systems and processes may also provide publishers, advertisers and/or service providers improved processes and solutions to secure and protect the content they deliver or provide.

An aspect of the disclosure comprises a method of controlling network access, the method comprising: receiving at an engine (e.g., a URL rewrite engine) comprising hardware a content request from a client device coupled to a local network; accessing, by the engine, a first set of rules (e.g., business rules), the first set of rules comprising a combination of meta rules and content rules; applying, by the engine, the first set of rules to the request or the requested content, or both the request and the requested content, to determine how the content request, the content, or both the content request and the content, are to be processed; and based at least in part on the application of the first set of rules, rewriting the request, denying the request, or modifying the requested content, by the URL rewrite engine.

An aspect of the disclosure comprises a system comprising: a data store configured to at least store computer-executable instructions; and a hardware processor in communication with the data store, the hardware processor configured to execute the computer-executable instructions to at least: receiving a content request from a client device coupled to a local network; accessing a first set of rules, the first set of rules comprising a combination of meta rules and content rules; applying the first set of rules to the request or the requested content, or both the request and the requested content, to determine how the content request, the content, or both the content request and the content, are to be processed; and based at least in part on the application of first set of rules, modifying the request, denying the request, or modifying the requested content.

An aspect of the disclosure comprises a non-transitory computer-readable storage medium storing computer executable instructions that when executed by a computing device cause the computing device to perform operations comprising: receiving a content request from a client device coupled to a local network; accessing a first set of rules, the first set of rules comprising a combination of meta rules and content rules; applying the first set of rules to the request or the requested content, or both the request and the requested content, to determine how the content request, the content, or both the content request and the content, are to be processed; and based at least in part on the application of the first set of rules, modifying the request, denying the request, or modifying the requested content.

### BRIEF DESCRIPTION OF THE DRAWINGS

The disclosed aspects will hereinafter be described in conjunction with the appended drawings, provided to illustrate and not to limit the disclosed aspects, wherein like designations denote the elements.

FIG. 1 illustrates an example architecture for a content easement management system.

FIG. 2 illustrates an example process for allowing or restricting access of selective content based on the access provider's and/or the user's pre-determined settings.

FIG. 3 illustrates an example user interface.

FIG. 4 illustrates an example process for verifying a publisher's Internet credentials and applying system rules.

FIG. 5 illustrates another example user interface.

FIG. 6 illustrates another example process for verifying a publisher's Internet credentials and applying system rules.

FIG. 7 illustrates another example user interface.

FIG. 8 illustrates an example process for verifying a publisher's Internet credentials and applying system rules.

FIGS. 9 and 10 illustrate example DNS lookup processes.

FIG. 11 illustrates an example screen shot of a webpage and associated HTML code.

FIG. 12 illustrates an example process without a translation system.

FIG. 13 illustrates an example process with a translation system.

FIG. 14 illustrates an example cache substitution process.

FIG. 15 illustrates a translation system interacting with a RADIUS server.

FIG. 16 illustrates an example workflow.

FIGS. 17, 18, and 19A-B illustrate example processes for monitoring and processing URLs.

### DESCRIPTION

Certain embodiments of a translation system, such as a reference encryption and security translation system (RESTS), described herein may provide network administrators and access providers with technologies to better manage the security, delivery, content, and/or resources transmitted over networks, including their own networks. Optionally, such embodiments may also provide publishers, advertisers and service providers improved processes and solutions to secure and protect the content they deliver or provide.

Certain embodiments of a content easement and management system (CEMS) described herein may enable bandwidth/Internet access providers and/or premise operators to enable the monitoring and modification of content provided over their network and/or infrastructure.

Certain embodiments of a CEMS described herein may enable bandwidth/Internet access providers and/or premise operators to empirically track and collect entrance revenues (e.g., on a standardized basis) for advertising and/or content provided over their networks and/or infrastructure. Optionally, these revenues may be employed to lower or eliminate consumer access costs by reducing or offsetting the access provider's infrastructure costs to enable Internet access. In addition or instead, such revenues may be used to improve consumers' access experience by enhancing access to more quality content and restricting distracting or irrelevant content such as popups, or distracting advertisements that are typically unwanted by consumers.

Today, access providers have few tools to protect their customers from inappropriate and potentially harmful content passing through their networks. Most transfer or avoid liability by requiring users to accept their Terms and Conditions before access is granted. Consumers and access providers often employ virus protection to look for suspect content that is previously known, but this is approach is not foolproof. Further, virus protection disadvantageously adds expense and reduces overall system and rendering performance.

In addition to potentially unsafe content, advertisers are paying high prices to reach consumers. The relatively few companies that aggregate and control advertising content are growing increasingly powerful. In addition, these powerful aggregators also install silent programs which collect large amounts of unchecked, unmonitored information about these consumers. By contrast, providers that enable Internet access, often at great expense, do not share in the advertising revenue and are often forced to increase their access fee to consumers to enable and sustain Internet access.

For example, consider that in less than one decade a small search engine company with limited or minimal content home page (Google) grew to be one of the most powerful companies with most of the acquisitions and revenues coming from controlling the placement of Internet advertisements. Certain companies are being investigated or fined by federal authorities for hacking, security breaches, privacy issues, unfair trade issues, effective paid censorship and more. Meanwhile, premise operators and access providers who pay for networks that deliver the ads, as well as consumers, whose resources are used to render the content, do not share in these revenues, and the revenues are retained by relatively few aggregators.

Consumers have come to accept that low cost or no cost access to programming or content is subsidized by paid advertisement but few have realized how this has affected the industry. As noted above, Internet access providers and premise operators are paying higher bandwidth costs and purchasing more access equipment to enable convenient access to content for consumers. Meanwhile, access providers and premise operators receive little or no revenues from the advertisers or the few companies controlling the delivery of these advertisements. In order to hold down costs, access providers and premise operators have resorted to limiting bandwidth or site access to consumers or charging more for enhanced convenience. For example, some offer tiered access for a quality experience, or block sites with notoriously heavy streaming content. Aside from simply limiting bandwidth or blocking specific Internet destinations, access providers and premise operators lack an adequate ability to control or monetize content and advertising being displayed in their premise and delivered over their equipment. Certain users that consume large amounts of content, can effectively tune to any channel/URL, consume a disproportionate amount of shared bandwidth (clog), watch any desired programming, or improperly use this access without the knowledge or permission of the access providers, which typically causes the experience of others to degrade.

Many access providers transfer liability for access and many have turned to companies who can limit bandwidth or create tiered pricing to make these services available to consumers without losing money. Nonetheless, the model for Internet access providers and premise operators is out of balance.

Certain embodiments of the CEMS address some or all of the foregoing deficiencies in conventional approaches, by re-establishing balance and creating a level playing field for advertisers, consumers and Internet access providers that is measureable and auditable.

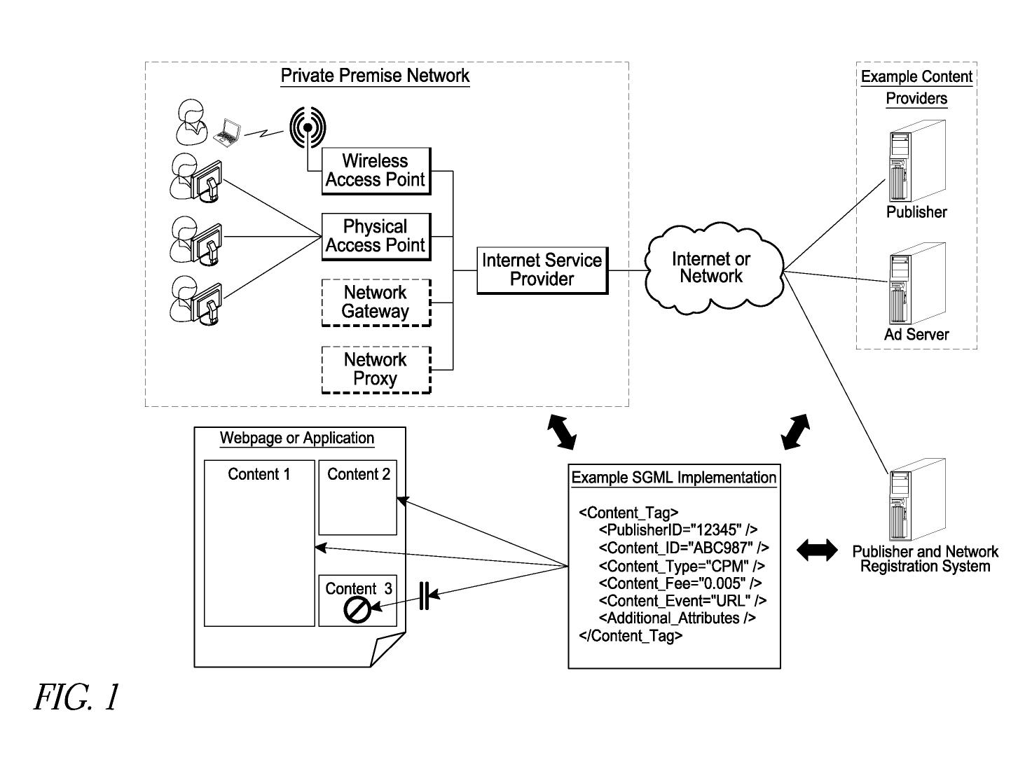

Embodiments of the CEMS can be implemented as software or firmware that may run on one or a plurality of computer system (including one or more processing devices) connected to a network and/or via the use of dedicated hardware. FIG. 1 illustrates an example architecture that may enable the protection of both end users and the network access providers that enable end user access. Other components and configurations may be used as well.

Consider in FIG. 1 that a user browses a webpage or app, and this webpage contains a multitude of content from different sources that is often dynamically created and determined only after reaching the user's connected device. For example, the connected device may be a terminal including a display and user input device. By way of example and not limitation, a terminal may be in the form of a general purpose computer, a laptop computer, a tablet computer, a phone, a networked television, a gaming device, etc. In this example, the content publisher may surround some or all the content it publishes with HTML tags that identify the content source, the type of content that is being transmitted, the content rating, and other attributes that can be used to evaluate the safety and value of this content to the access provider and end user. Thus, for example, the tags may be monitored, and based at least in part on an examination of the tags or content, a determination may be made as to which content is to be displayed and which content is to be blocked or substituted with other content.

For illustrative purposes, FIG. 1 demonstrates that Content 1 and Content 2 are permitted by the CEMS; however, Content 3 fails to meet the requirements (e.g., specified by an access provider, premise operator, and/or user) and is blocked or substituted by the CEMS without affecting other content or page layout. In this example, Content 1 may be a news article of known origin as determined by inspection of Content 1 and/or associated metadata, such as associated tags (e.g., HTML tags) or page content. The tags or page content may identify the publisher as CNN or Wall Street Journal, for example. The content type may be labeled, via a tag or otherwise, as news, the fee (e.g., charged by the access provider or premise operator or a CPM (Cost per mille/thousand), CPC (Cost per click), or other fee (e.g., revenue) that the publisher or advertiser is willing to pay) may be specified via a tag or otherwise as $0.00, and the event tag (e.g., on mouse click, on advertisement loading, on page load, etc.) may have a null value or a token that might be time- or volume-based. In various embodiments, one or more of the tags and/or tag values may be omitted. For example, as described in more detail below, in some embodiments the fee, content type, height, and/or other attributes and associated tags may be omitted. In some embodiments, the decision of whether to permit an advertisement to be displayed may be based on an overriding contract, for example 20% of all advertisements may be served so long as the ad server company is current and registered. Payment may be reconciled at a later time based on the data.

In one embodiment, the fee charged/collected by the network provider may be determined by or specified in a registry associated with the CEMS based on previously agreed to terms, such as 20% of the CPM. Optionally, if the fee is not acceptable or another advertiser is willing to pay a higher fee, the access provider may choose, via the CEMS, to select the ad from the advertiser offering the higher fee. Content 2 may be an advertisement from a well-known ad serving provider, such as DoubleClick or ValueClick. The content type may be advertisement, the fee (as described above) may be $0.001 and the event may include additional actions if the user clicks on the advertisement. In this example, Content 3 may also be an advertisement but did not include the needed tags for identification purposes and/or failed to meet permission criteria, as indicated by a rating toll, such as a content rating for a given site. The CEMS may examine Content 3 and/or associated tags and determine that if failed a source identification determination and/or permission criteria. In some embodiments, the CEMS may record the display of the advertisement, and document the ad server URI or other identifying information. The advertiser may be billed at a later date, or if the advertiser does not have a valid current account (e.g., due to nonpayment or failure to enter into payment contract), the advertisement may be blocked.

In some embodiments, ad toll technology may be employed by the system. In an example embodiment, one or more toll booth locations or sites register with the registry and a given toll booth location records the passage of an ad based in whole or in part on delivery to a user.

Optionally, an advertisement has to be delivered in order for the network provider and/or publisher to be provided payment with respect to the advertisement. In an optional embodiment, if an advertisement traverses networks of multiple network operators, then revenues or payments with respect to the advertisement may be split among the multiple network operators and, in certain circumstances, the user to whom the advertisement is delivered. For example, if an ad traverses the networks of three network operators in order to reach the end user terminal, and each of the network operators (and optionally the user) is registered with the system, then the revenue may be split based at least in part on one or more network parameters (how many network segments (e.g., network operator A might traverse the advertisement from point A to B via a national network link, network operator B might traverse the advertisement from point B to point C via a local ISP link, and network operator C might traverse the advertisement from Point C to the user terminal via their Wi-Fi network), how far or number of hops (e.g., the number of routers or routes traversed from the sender to the receiver, in which optionally a given router/route may have an associate detailed cost)) and/or what percentage or revenue cut is indicated by the ad tag itself, registry rules, and/or otherwise. The network parameters may be equally or unequally weighted in determining how the revenues/fees are to be split.

Access requirements may optionally be configured and managed in an access profile record via a web application or client application accessed by a customer or account manager. This profile may include rules or access thresholds based on physical location, bandwidth characteristics, virtual location, cost metrics, or location type such as a hotel property or small coffee shop business and other such features. Rules may also be configured based on account, physical or logical network, virtual network characteristics and/or the type of connection such as, but not limited to, free, paid limited access, or paid full access. These rules may also be automatically or dynamically derived based on real-time factors or conditions such as active URL, page content, time of day, day of week, use, current events or other factors that might affect the triggering or targeting of dynamic content.

A non-limiting example illustrating an example process flow will now be described. A user may access a free public Wi-Fi network hotspot (that is privately owned) with terms and conditions covering network usage and advertising (e.g., where the user clicks on an accept control or otherwise indicates acceptance of the terms and conditions). When the user accesses Internet content, such as a web page, via the private network, the rules defined by the private network operator for the private network may cause the system to selectively enable (or block) specific advertisements to pass through the private network based on specific conditions, such as, by way of example, appropriate rating, publisher URL or node, and/or pre-established agreements such as an access fee or threshold revenue amount. By way of further example, an advertiser may utilize an HTML tag and URL reference to return their advertisement. The ad tag may be in the form of an HTML place holder, and may be inserted by the publisher when a page (e.g., an HTML Web page) is served. Optionally, when the page reaches the user terminal, an ad tag script is executed by the browser, and passes back information to the ad provider system, such as cookie data, IP address and/or the current URL, enabling the ad provider to dynamically select a relevant or best ad for the user. The ad image may not actually be in the page. Instead, a reference to a program that will find the image may be included in the tag. The CEMS, applying the private network operator rules, may parse this tag and/or programmatically reference the tag's characteristics and determine not to show this advertisement if the content rating is determined (e.g., by inspecting a content rating tag, or by calling back for the object to display) to be not appropriate for the viewer and/or the location (e.g., the website the viewer is viewing or the physical facility housing the Wi-Fi hotspot). For example, a coffee shop with a hotspot may not want obscene or offensive material to be displayed on user terminals, within the coffee shop, accessing the hotspot. The rules, as applied by the CEMS, may also evaluate a revenue attribute for this particular advertisement (e.g., by inspecting an appropriate tag) by comparing the revenue attribute to an acceptance threshold value as pre-specified by the network operator or as otherwise specified, and choose not to allow the advertisement to pass through the network if the revenue attribute is determined to be below the acceptance threshold.

If, in this example, the CEMS determines that revenue is above the acceptance threshold (as pre-specified by the network operator or as otherwise specified) and the rules indicate the advertisement is to be allowed to pass, the system may enable the advertisement to be delivered to the user's terminal, the delivery of the advertisement may be recorded by the system, optionally in association with some or all of the associated tag information, such as tag information identifying the publisher, the advertisement, the revenue offered for the ad, the network or networks the advertisement passes through, and/or other such information. Such stored tag information may be utilized by the CEMS or otherwise to determine who revenue is to be collected from. For example, the CEMS may use the tag information to collect revenue from (e.g., charged to) the registered publisher of the ad.

In a scenario in which the advertisement had to pass through multiple private networks (previously registered in the network), such as passing first through an Internet service provider (ISP), and then through an operator's private hotel network, and finally to a Wi-Fi network operated at a concession shop at the hotel, then a portion of the revenue may be shared between each of these operators equally or computed based on the network length, cost, number of routers or other similar characteristics of the networks. Optionally, not all network private operators whose networks the advertisement traverses are entitled to such revenue. Optionally, where a user's terminal (e.g., a computer) may also contribute to this delivery (e.g., by receiving and display the advertisement), and the rules may also be applied with respect to the user and/or user terminal, the user may share in revenues enabling the distribution of content. The registry may also store user-specific data and enable the user to also configure rules governing the permission or denial of content passing into their computer in the same or similar manner as the network operators.

Optionally, the CEMS does not censor based on content subject matter, but rather validates the source, and based on the source validation results, may selectively enable content to be provided for display on a user terminal or may prevent such display from occurring. For example, the CEMS may optionally act as an independent registration system to help validate publishers and help access providers and users monetize their equipment.

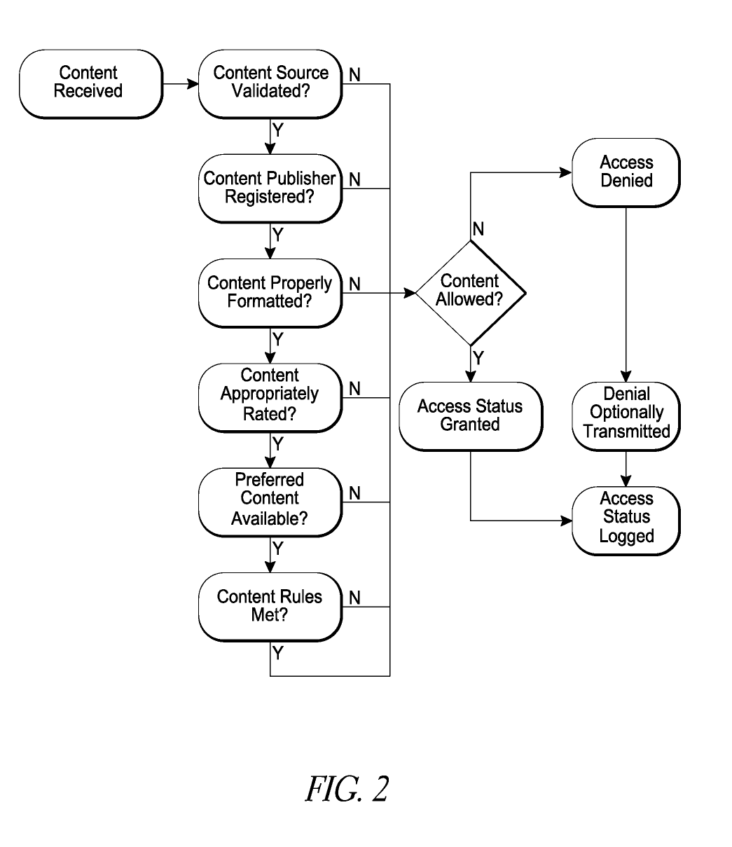

For this example, CEMS may employ the example process shown in FIG. 2 to selectively allow or restrict access of content based at least in part on the access providers and/or the user's pre-determined settings. Unlike conventional URL or ad blockers applications, the CEMS may instead or in addition evaluate the source and attributes of a given content element to determine whether the defined rules of the access provider and/or user indicate that this content is permitted to be routed over their equipment and/or provided to the user terminal (e.g., laptop, tablet, desktop, cell phone, networked television, etc.), or whether the rules indicate that the content is not to be routed over their equipment and/or provided to the user terminal. In some embodiments, multiple network providers are involved in the transmission. In some embodiments, the network provider closest to the user may have the highest priority for defining rules and/or permitting content to be routed over their equipment.

Additionally, an access provider or user may permit content to be routed and/or displayed for value received. For example, the access provider may allow advertising content to pass over their network for a fee to help offset the cost of the equipment necessary to enable the user's connection. As another example, there may be users who do not particularly like advertisements but who are willing to selectively accept the display of such advertisements on the user's terminal in exchange for free access or content. However, by way of example, the user may want to limit the type or size (e.g., in terms of the number of bytes) of the advertisement when bandwidth is limited or shared. Thus, the system may enable the user to specify ad acceptance criteria, which may include size, type (e.g., text, graphics, photographs, video, and/or audio), source, rating, etc., which will be used by the system to determine whether or not to permit an ad to be displayed to the user. This form of advertisement control may also appeal to access providers who often pay significantly more to enable greater bandwidth. By restricting undesirable content from traversing their systems, access providers can reduce their costs and improve user browsing experience without requiring the installation of expensive equipment that throttles bandwidth at the network layer.

A publisher and network registration system may be implemented as a client program or an Internet application that may permit publishers and/or advertisers to register with a registry their entity, URL (or other locator information), and optionally other specific data such as publisher category (or categories), contact information, revenues share percentage, types of content, rating status, and optionally enables these registrants to create accounts to manage their registration profile.

The publisher and network registration system may optionally utilize a database or other data store to store certain characteristics regarding content publishers including, but not limited to, the publisher name, the business entity, the publisher URL, the IP address or IP addresses assigned to or used by the publisher, the type of published content, the publisher's self-determined rating (e.g., an age appropriateness rating, a violence rating, a sexual content rating, an obscene language rating, etc.), a public or industry accepting rating (e.g., an age appropriateness rating, a violence rating, a sexual content rating, an obscene language rating, etc.), fees associated with certain content, and/or other such information to enable the registry to accurately define and validate publishers.

In some embodiments, the publisher and network registration system may be implemented as a database in a central computer (which may comprise multiple geographically distributed systems) that is referenced by the network nodes in determining whether to pass published content to a viewer. This technique enables certain information to be omitted from the individual ad tags. For example, the fee structure for a particular publisher may be standardized, and a given an ad served that is provided by that publisher may be assigned that particular fee structure. Accordingly, the fee structure need not be included in the individual ad tags, but rather may be retrieved from the central computer containing the publisher and network registration system.

In other embodiments, the publisher and network registration system may be implemented as a syndicated database or list, in which the database or list is copied to distributed locations on the network (e.g., the Internet). For example, the distributed locations may include a series of distributed servers or proxies. As noted above, this may permit certain information to be omitted from individual ad tags, such as Type, Fee, etc.

Accordingly, the database of registered ads may be accessed in a number of ways, including by way of example, via an HTML page, as a syndicated reference list, and/or as a central reference list. In any of these approaches, whether a given advertiser has agreed to pay a fee can be determined by querying the database. If the database response to the query with an indication advertiser has not agreed to pay such a fee, the content may be blocked, and different content may be served instead.

In order to prevent or inhibit fraud, spoofing or other method to circumvent validation, the publisher and network registration system may optionally utilize other certificate authorities or listing services, such as the Internet Directory Naming Service (DNS) by way of example, to further validate a publisher. For example, the Internet DNS is a service that resolves and translates URLs, such as Yahoo.com, Google.com, and NYTimes.com, into the physical Internet IP Addresses that represents a URL or URI or other such reference, enabling computers and routers to connect with their respective Internet services. For example, an Internet PING for Yahoo.com may return 209.191.122.70 from DNS Service hosted by AT&T. A PING for Google.com and NYTimes.com returns 74.125.224.180 and 199.239.136.200 respectively. This information may be used by the system to compare and match published content source address with registered addresses to validate publisher integrity. Other network resolution tools such as WHOIS, NSLOOKUP, TRACERT and others may also be used to determine the publishers true network identity.

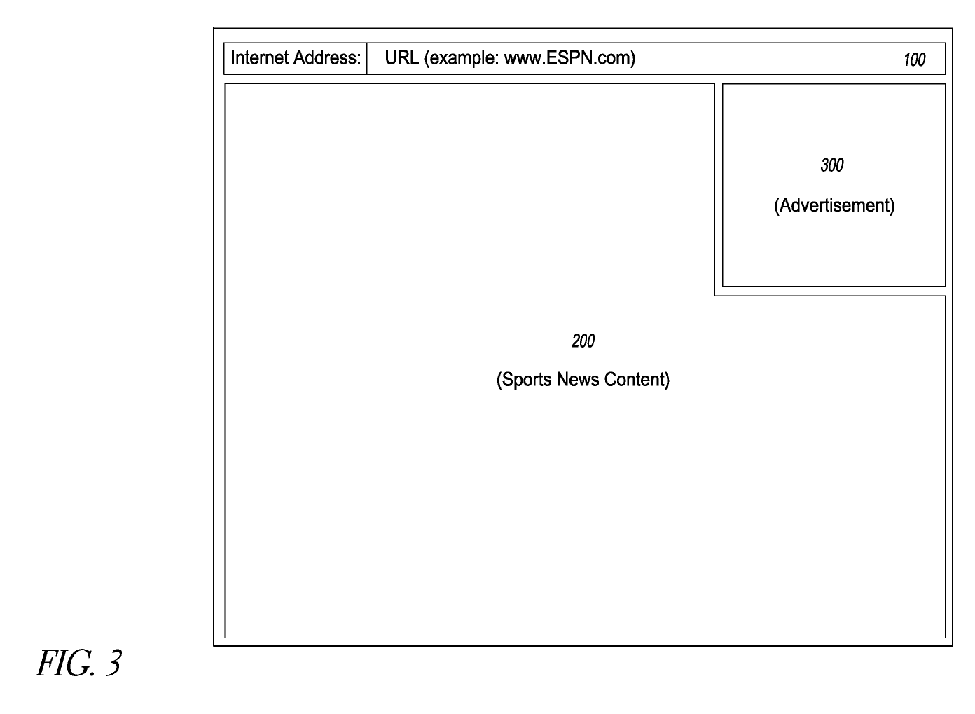

For example, FIG. 3 illustrates further the utilization of the DNS to help verify a publisher's Internet credentials. In some embodiments, DNS may be expanded to help serve the role of register as a partner. In the illustrated example, a popular sports destination site 100 is providing recent sports news 200, and embedded next to or in-line with the article is an advisement from a large ad network or well-known advertiser 300.

In this example, the sport news site 100 has previously registered with the publisher and network registration system as a publisher, and listed its known IP addresses from which the site 100 publishes. The news article 200 being published is encapsulated with HTML content tags that reference respective registry identifier(s) and other attributes regarding the article 200 content. Similarly, the advertiser 300, providing the advertisement and/or ad tag, also encapsulates their content with HTML tags referencing respective registry identifier(s) and other attributes describing the content being provided by the advertiser (an advertisement).

By way of example, the advertiser may register their entity and IP addresses, which may be used by the system to authenticate the advertiser when placing the advertiser's ads. The advertiser may also specify, via a form hosted by the system or otherwise, a revenue sharing specification (e.g., a general revenue share of 25%) which would be applied to the advertiser's paid ads. Optionally, an ad tag itself might include attributes (e.g., value pairs) identifying the publisher, advertisement, advertisement dimensions, advertisement type (e.g., CPM, CPC, etc.), ad revenue (e.g., ad revenue per impression), ad rating (e.g., G, Youth, PG, PG13, R, Mature, etc.), ad event (e.g., pay per click), ad encoding format (e.g., UTF), etc. The following are example attributes that may be associated with a particular example ad:
Publisher ID=234,
Ad ID=Number to track a particular impression for audit,
Ad Size/Shape
Ad Height=300
Ad Width=250
Ad Type=CPM
Ad Revenue=0.0001/Ad or 0.1/1000 impressions
Ad Rating=G
Ad Event=Pay-Per-Click
Ad Local=UTF

As noted previously, in some embodiments one or more of these attributes may be omitted from the ad tag. The system may store, maintain and provide/output an audit record report indicating the ad detail and the network(s) the ad traversed, and optionally including an identification that the ad was delivered and/or displayed on the user's terminal.

Therefore, in certain embodiments, the ad network may also register with system and may include an ad network identifier in the ad network's data associated with the ad.

Optionally, the foregoing tags and/or other related tags may form the basis of a formal or informal standard, so that publishers may expose their revenue paid via a tag attribute (which may be relatively fast but viewable by end users and competitors) and/or a via reference look-up table where the look up is performed using an identifier, such as an Ad ID, that enables the system to identify the corresponding access rule(s) to be used to query the revenue amount and let the ad pass so that it may be delivered to a viewer terminal or prevent the ad from reaching the viewer terminal and/or from being displayed via the viewer terminal. If the ad is prevented from reaching the viewer terminal, another ad may be selected and substituted by the system (e.g., based on user demographics and/or user interests, or without taking into account user specific information) to take the place of the banned advertisement, and the replacement ad may be displayed with the surrounding content (if any) on the user's terminal.

For the purpose of this example the following scenarios may occur in determining whether to permit an advertisement from an advertiser to be permitted to pass through one or more network provider systems and be displayed on a user terminal:
the advertiser has not previously registered with the registry;
the advertiser has previously registered with the registry and provided all the information to be validated in order to permit the advertiser's ads to be permitted to pass to the user terminal;
the advertiser has previously registered and has not provided all the information to be validated;
the advertiser has previously registered with the registry, however the advertiser's account is inactive due to nonpayment or failure to enter into payment contract;
the advertiser has previously registered and has provided all the information to be validated but was not allowed to pass because of specific conditions or based at least in part on rules set by the network owner;
the tag represents a previously registered advertiser but failed authentication or appears fraudulent and was not permitted.

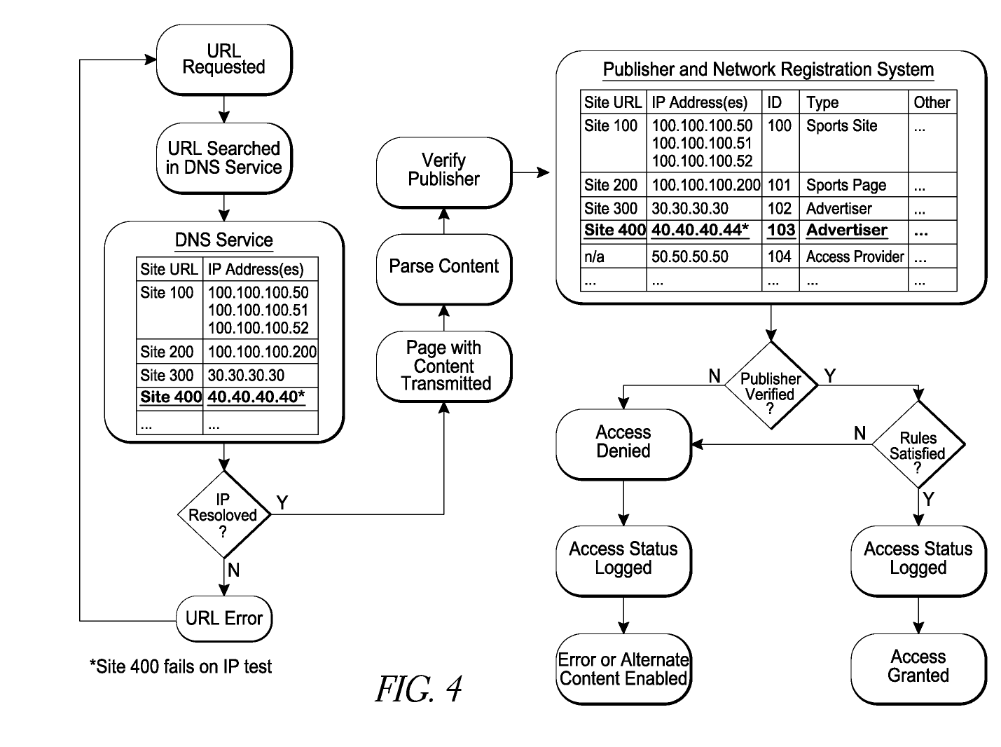

To simplify this example for illustrative purposes it will be assumed that the sport site 100 may have previously registered with the publisher and network registration system and satisfies all authentication criteria needed to permit their content to pass, and only consider the Advertiser for this authentication example. FIG. 4 helps illustrate this example.

Given that HTTP and similar Internet protocols use URL references to link content to a source publisher, then in this case the Advertiser's 300 content would have been served either directly from the Site Publisher 100 or as a reference using ad tags or a URL that link to the Advertiser's 300 content or advertisement. Since the source of the content is inherently resolved by the DNS, its origination can be validated using the publisher and network registration system before the content is permitted to pass over the access provider's network.

If the advertiser 300 has previously registered and entered its correct IP address then the values returned by the DNS will match those entered for this specific advertiser 300 thereby enabling the CEMS to validate the authenticity and integrity of the publisher. If the advertiser 300 has not previously registered or the data stored in the advertiser's 300 profile does not match DNS values, the CEMS may prevent or inhibit the content from passing over the network at issue. For example, the CEMS may strip the advertiser's 300 content by removing links, files, or documents from the site 100. In some embodiments, the content may be blocked based on the name of the reference, the URL, logical name with or without DNS requirement, MIME Type (e.g., jpg, mp4, etc.), protocol, or other approaches. If no alternative content is provided for the blocked content, an error message, such as an HTTP error (e.g., 404 error (page not found)) may be provided in place of the blocked content. In some embodiments, if the content is prevented from reaching the viewer terminal, other content may be selected and substituted by the system to take the place of the blocked content, and the replacement content may be displayed with the surrounding content (if any) on the user's terminal. The substitution content may optionally be selected based at least in part on relevancy to the user, relevancy to the surrounding content, size, media type, a fee paid by a publisher of the substitute content, and/or otherwise. In some embodiments, the HTTP error such as a 404 error (page not found) is provided, which may then be overlaid or replaced with replacement content.

If the advertiser 300 has registered with the registry, but the advertisement data failed to be validate, a message or error status may be transmitted by the system to the registered advertiser by email, instant message, short message, application, or other technique, and the message or error status may also be logged in the registry database, which may be provided via an advertiser account user interface for that advertiser to review. However, optionally, it is not sufficient for the advertiser 300 to be validated in order to be permitted to pass through the access providers' network. Optionally, there may be several rules or prerequisites each content provider or advertiser must meet before the content is permitted to traverse their networks.

Advertisers themselves may be sensitive with respect to where their advertisements are displayed (e.g., on which pages or websites). For example, certain brand companies may avoid displaying advertisements on unwholesome websites. Conversely, certain companies targeting products to a mature audience may wish to display advertisements particularly on unwholesome websites. Additionally, websites may be sensitive to the type of advertisements that are displayed on their sites. Certain embodiments enable advertisers to specify rules which will govern how and where the CEMS will permit their advertisements to be displayed.

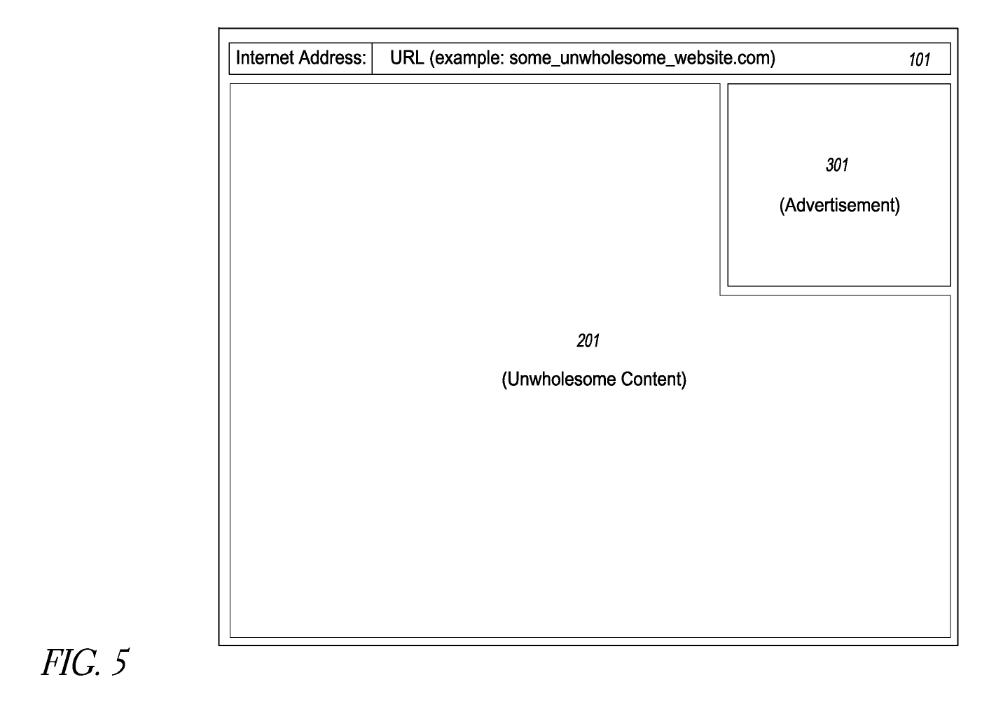

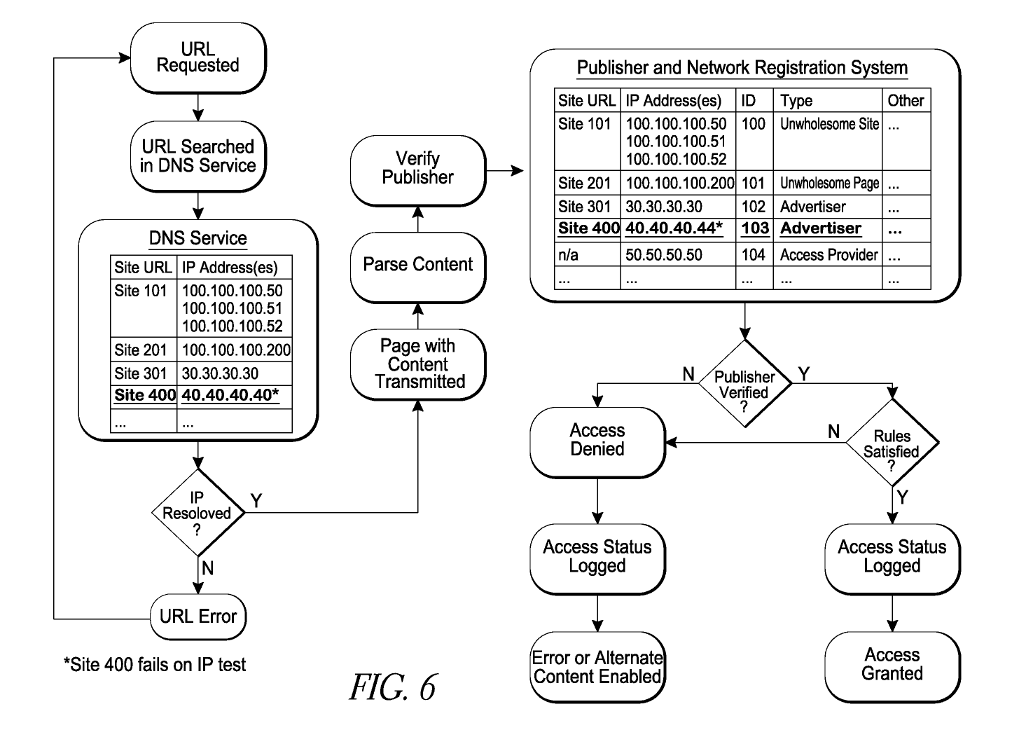

For example, FIGS. 5 and 6 illustrate another example process utilizing the DNS to help verify a publisher's Internet credentials and in applying system rules. In this example, an unwholesome website 101 is providing unwholesome content 201, and embedded next to or in-line with the article is an advisement from a large ad network or well-known advertiser 301. By way of example, the unwholesome content may be related to pornography, gambling, violence, or various other types of content that might offend certain users.

In this example, the unwholesome website 101 may have previously registered with the publisher and network registration system as a publisher, and listed its known IP addresses from which the site 101 publishes. The unwholesome content 201 being published may be encapsulated with HTML Content tags that reference their registry identifier(s) and other attributes about this content. Similarly, the advertiser 301, providing the advertisement or ad tag, may also encapsulate their content with HTML tags referencing their registry identifier(s) and other attributes describing their content.

By way of example, the advertiser may register their entity and IP addresses, which may be used by the system to authenticate the advertiser when placing the advertiser's ads. The advertiser or other entity may also specify, via a form hosted by the system or otherwise, whether the particular advertisement 301 is one that should only be displayed on wholesome websites, i.e. whether the advertisement 301 is wholesome-targeted. Likewise, the advertiser or other entity may specify, via a form hosted by the system or otherwise, whether the particular advertisement 301 is one that should only be displayed on unwholesome websites, i.e., whether the advertisement 301 is unwholesome-targeted. For example, as noted above, certain brands may only wish to display advertisements on wholesome websites so as not to tarnish the brand. This categorization of the advertisement 301 may be offered by the advertiser, or may be determined by another entity. Optionally, an ad tag (or tags) itself might include these attributes. As noted previously, in some embodiments one or more of these attributes may be omitted from the ad tag itself. In some embodiments, categorization can be site/venue driven. For example, unwholesome content may be permitted within a hotel (as it is private), but not in a public café. Accordingly, in some embodiments the same advertisement from the same publisher may be treated differently according to the venue. As described elsewhere herein, if unwholesome content is blocked, a different advertisement may be placed to be displayed in its place. In various embodiments, the replacement advertisement may be selected from the same publisher or from a different publisher.

Optionally, the foregoing tags and/or other related attributes may enable the system to identify the corresponding access rule(s) to be used by the system to determine whether to let the ad pass so that it may be delivered to a viewer terminal or to prevent the ad from reaching the viewer terminal and/or from being displayed via the viewer terminal. For example, if the advertisement 301 is determined by the system (e.g., based on a respective ad tag) to be wholesome-targeted, the system may prevent the ad from reaching the viewer terminal in the scenario that the content 201 is unwholesome. If the ad is prevented from reaching the viewer terminal, another ad may be substituted by the system to take the place of the banned advertisement, and the replacement ad may be displayed with the surrounding content (if any) on the user's terminal. In some embodiments, an unwholesome-targeted ad may be selected for replacement of the blocked advertisement.

For the purpose of this example the following scenarios may occur in determining whether to permit an advertisement from an advertiser to be permitted to pass through one or more network provider systems and be displayed on a user terminal:
the advertiser has not previously registered with the registry;
the advertiser has previously registered with the registry, however the advertiser's account is inactive due to nonpayment or failure to enter into payment contract;
the advertiser has previously registered with the registry and has provided all the information to be validated and permitted to pass;
the advertiser has previously registered with the registry and has not provided all the information to be validated;
the advertiser has previously registered and has provided all the information to be validated but was not allowed to pass because of specific conditions or based at least in part on rules set by the network owner;
the tag represents a previously registered advertiser but failed authentication or appears fraudulent and was not permitted;
the advertiser has previously registered and provided all the information to be validated but was not allowed to be displayed on the unwholesome site because the advertisement is identified as wholesome-targeted.

To simplify this example for illustrative purposes, it is assumed that the unwholesome site 101 has previously registered with the publisher and network registration system and satisfies the needed authentications to permit their content to pass, and so only the advertiser-specified criteria is discussed for this authentication example. Further, the unwholesome site 101 has been identified by the publisher and network registration system (whether by the site 101 itself or by another entity) that it is unwholesome. In some embodiments, the publisher and network registration system may maintain a list of identified unwholesome sites. In some embodiments, the site 101 may be analyzed by the publisher or network registration system to determine whether or not it may be categorized as unwholesome.

Given that HTTP and similar Internet protocols use URL references to link content to a source publisher, then in this case the advertiser's 301 content would have been served either directly from the site publisher 101 or as a reference using ad tags or a URL that link to the advertiser's content or advertisement. Since the source of the content is resolved by the DNS, its origination can be validated using the publisher and network registration system before the content is permitted to pass over the access provider's network.

If the advertiser 301 has previously registered and entered its correct IP address, then the system will determine that the values returned by the DNS match those entered for this specific advertiser 301, thereby validating the authenticity and integrity of the publisher. If the advertiser 301 has not previously registered or the data stored in the advertiser's 301 profile does not match DNS values, the system will prevent the content from passing over the network. For example, the CEMS may strip the advertiser's 301 content by removing links, files, or documents from the site 101.

If the advertiser 301 has registered but the system determines that the advertisement has been identified as wholesome-targeted, the system may prevent the advertisement from being displayed on a webpage of the unwholesome site. If no alternative content is provided for the blocked content, an error message, such as an HTTP error (e.g., 404 error (page not found)) may be provided in place of the blocked content. In some embodiments, if the content is prevented from reaching the viewer terminal, other content may be selected and substituted by the system to take the place of the blocked content, and the replacement content may be displayed with the surrounding content (if any) on the user's terminal. The substitution content may optionally be selected based at least in part on relevancy to the user, relevancy to the surrounding content, size, media type, a fee paid by a publisher of the substitute content, and/or otherwise. In some embodiments, the HTTP error such as a 404 error (page not found) is provided, which may then be overlaid or replaced with replacement content. In some embodiments, a replacement ad may be inserted in place of the blocked advertisement. For example, an unwholesome-targeted advertisement may be inserted in place of the blocked advertisement. Optionally, there may be several rules or prerequisites each content provider or advertiser must meet, as determined by the system, before the content is permitted.

As noted above, certain companies targeting products to a mature audience may wish to display advertisements particularly on unwholesome websites. Additionally, it may be undesirable to display unwholesome-targeted advertisements on wholesome websites.

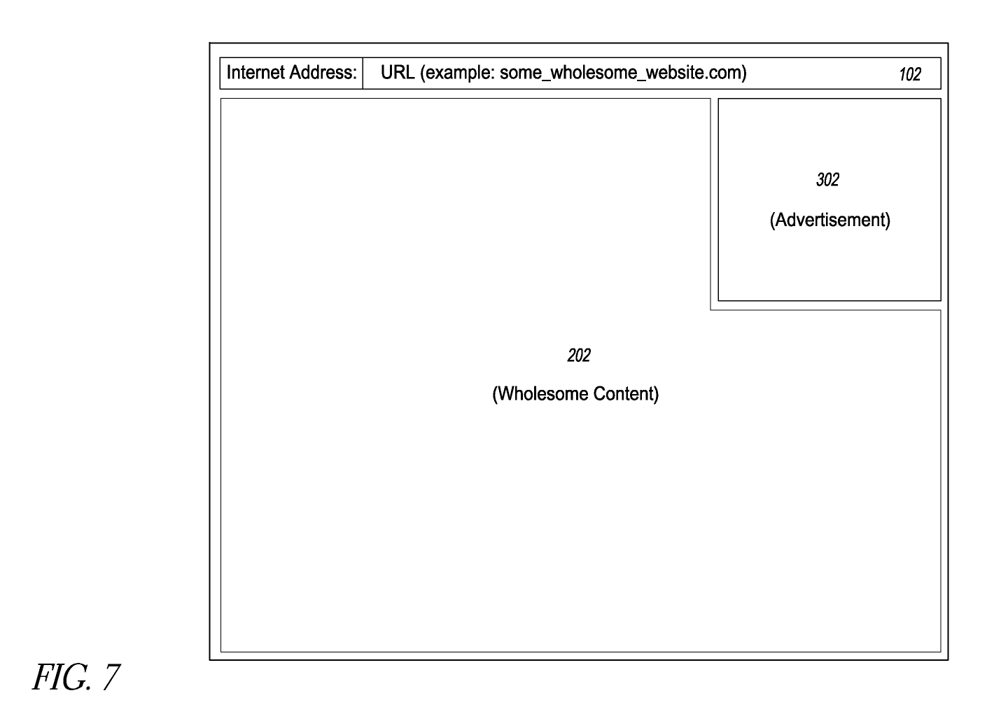

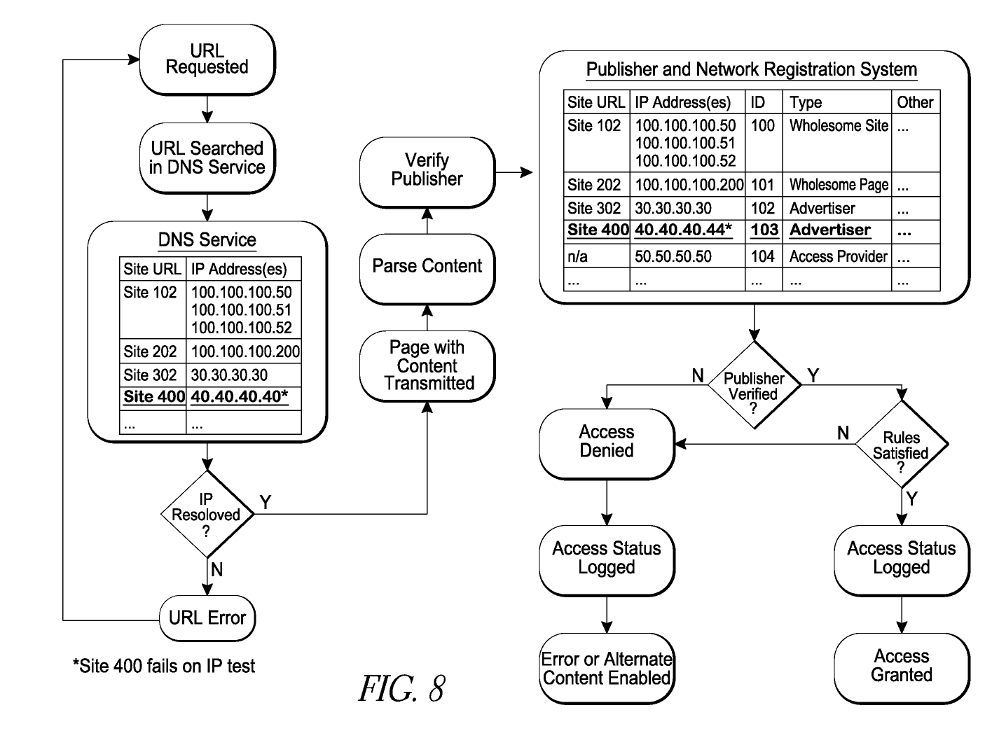

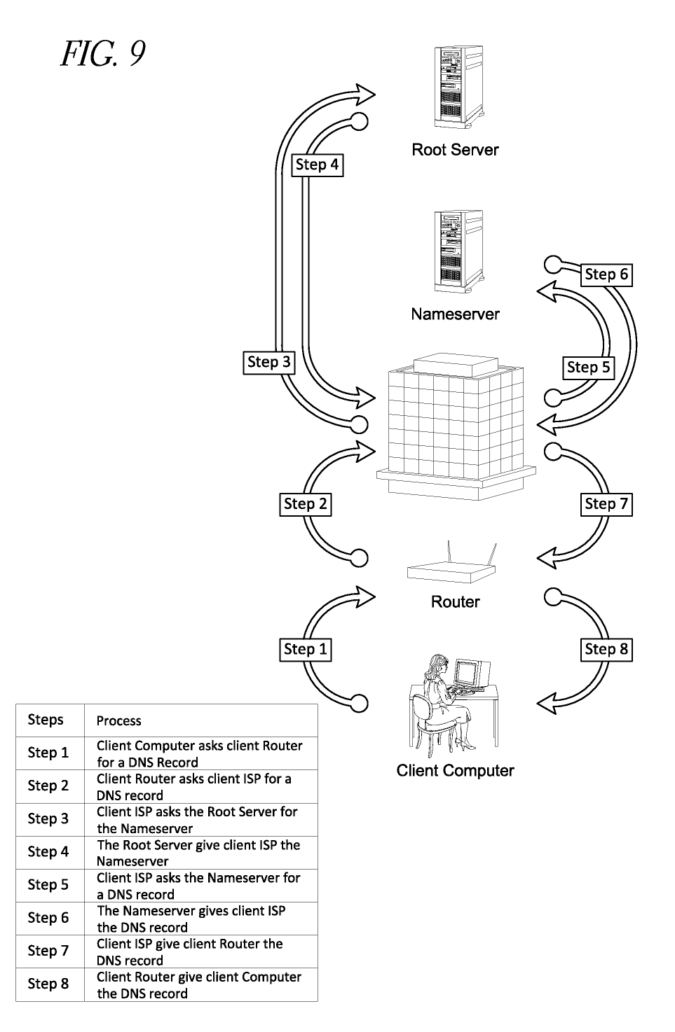

For example, FIGS. 6 and 7 illustrate another example process utilizing the DNS to help verify a publisher's Internet credentials and in applying system rules, in which a wholesome website 102 provides wholesome content 202. Embedded next to or in-line with the wholesome content 202 is an advertisement 302. In various embodiments, the wholesome content may be directed to general audiences, with little or no content that may offend certain users.

The advertiser or other entity may also specify, via a form hosted by the system or otherwise, whether the particular content from advertiser 302 is one that should only be displayed on wholesome websites, i.e. whether the content from advertiser 302 is wholesome-targeted. Likewise, the advertiser or other entity may specify, via a form hosted by the system or otherwise, whether the particular advertisement 302 is one that should only be displayed on unwholesome websites, i.e., whether the content from advertiser 302 is unwholesome-targeted. For example, as noted above, certain brands may only wish to display advertisements on unwholesome websites so as reach a desired user audience. This categorization of the content from advertiser 302 may be offered by the advertiser, or may be determined by another entity. Optionally, an ad tag itself might include these attributes. As noted previously, in some embodiments one or more of these attributes may be omitted from the ad tag itself.

Optionally, the foregoing tags and/or other related attributes may enable the system to identify the corresponding access rule(s) to be used to determine whether to let the ad pass so that it may be delivered to a viewer terminal or prevent the ad from reaching the viewer terminal and/or from being displayed via the viewer terminal. For example, if the content from advertiser 302 is determined to be unwholesome-targeted, the system may prevent the ad from reaching the viewer terminal in the scenario that the content 202 is wholesome. If the ad is prevented from reaching the viewer terminal, another ad may be substituted by the system to take the place of the banned advertisement, and the replacement ad may be displayed with the surrounding content (if any) on the user's terminal. In some embodiments, a wholesome-targeted ad may be selected for replacement of the blocked advertisement.

For the purpose of this example the following scenarios may occur in determining whether to permit an advertisement from an advertiser to be permitted to pass through one or more network provider systems and be displayed on a user terminal:
the advertiser has not previously registered with the registry;
the advertiser has previously registered with the registry and has provided all the information to be validated and permitted to pass;
the advertiser has previously registered with the registry, however the advertiser's account is inactive due to nonpayment or failure to enter into payment contract;
the advertiser has previously registered with the registry and has not provided all the information to be validated;
the advertiser has previously registered and has provided all the information to be validated but was not allowed to pass because of specific conditions or based at least in part on rules set by the network owner;
the tag represents a previously registered advertiser but failed authentication or appears fraudulent and was not permitted;
the advertiser has previously registered and provided all the information to be validated but was not allowed to be displayed on the wholesome site because the advertisement is identified as unwholesome-targeted.

To simplify this example for illustrative purposes it is assumed that the wholesome site 102 has previously registered with the publisher and network registration system and satisfies the needed authentications to permit their content to pass, and so only the advertiser specified criteria is discussed for this authentication example. Further, the wholesome site 102 has been identified by the publisher and network registration system (whether by the site 102 itself or another entity) that it is wholesome. In some embodiments, the publisher and network registration system may maintain a list of identified wholesome sites. In some embodiments, the site 102 may be analyzed by the publisher and network registration system to determine whether or not it may be categorized as wholesome.

Given that HTTP and similar Internet protocols use URL references to link content to a source publisher, then in this example the advertiser's content would have been served either directly from the site 102 or as a reference using ad tags or a URL that link to the advertiser's content or advertisement. Since the source of the content is resolved by the DNS, its origination can be validated using the publisher and network registration system before the content is permitted to pass over the access provider's network.

If the advertiser 302 has previously registered and entered its correct IP Address then the values returned by the DNS will match those entered for this specific advertiser 302 thereby validating the authenticity and integrity of the publisher. If the advertiser 302 has not previously registered or the data stored in the advertiser's profile does not match DNS values, the system will prevent the content from passing over the network. For example, the CEMS may strip the advertiser's 301 content by removing links, files, or documents from the site 101.

If the advertiser 302 has registered but the system determines that the advertisement has been identified as unwholesome-targeted, the system may prevent the advertisement from being displayed on a webpage of the wholesome site. If no alternative content is provided for the blocked content, an error message, such as an HTTP error (e.g., 404 error (page not found)) may be provided in place of the blocked content. In some embodiments, if the content is prevented from reaching the viewer terminal, other content may be selected and substituted by the system to take the place of the blocked content, and the replacement content may be displayed with the surrounding content (if any) on the user's terminal. In some embodiments, the HTTP error such as a 404 error (page not found) is provided, which may then be overlaid or replaced with replacement content. In some embodiments, a replacement ad may be inserted in place of the blocked advertisement. For example, a wholesome-targeted advertisement may be inserted in place of the blocked advertisement. Optionally, there may be several rules or prerequisites each content provider or advertiser must meet, as determined by the system, before the content is permitted.

In some embodiments, a website may be identified by the publisher and network registration system as fragile (e.g., likely to become dysfunctional upon blocking or replacing content). For such identified fragile sites, the system may refrain from blocking or replacing any advertisements. For example, some sites may be known to become dysfunctional upon blocking or replacing advertisements. These sites may be communicated to the system as fragile, or the system may independently determine whether such sites are fragile.

The publisher and network registration system may also help Internet access providers protect their customers from potential viruses because it optionally authenticates the source for a given script delivered to a computer. It also may help Internet access providers better manage their bandwidth by optionally implementing content publisher rules that actively select, or default to lower bandwidth content options, block content, or substitute preferred content over higher cost content.

The publisher and network registration system may also provide reporting services that enable publishers to view where and when their content was permitted entry and where (e.g., over which private networks, on which terminals) and when their content was not allowed. When their content was not allowed, the database may record and report reasons why the content as not allowed, such as poor ratings, inappropriate content, insufficient entry fee, lost to competitive bid, or other reasons rules or requirements implemented by the Internet access provider.

In many cases there may be several Internet access providers connected together to form a complete path from the publisher to the end user. This series of network connections may represent a content distribution network in which each of the connect segments may be registered in the content authentication registry.

The content authenticate registry service may also enable Internet Access Providers to register their networks and network nodes in this registry to enable the tracking and reporting of when and where content was permitted or denied access to pass through a particular network or portion thereof. This data may include information describing the network and the admission rules.

For more example details on the content easement and management system (CEMS) and associated processes, including those enabling bandwidth/Internet access providers and/or premise operators to control the monitoring and modification of content provided over their network and/or infrastructure, see application U.S. patent application Ser. No. 13/896,057, entitled “CONTENT EASEMENT AND MANAGEMENT SYSTEM FOR INTERNET ACCESS PROVIDERS AND PREMISE OPERATORS,” filed on May 16, 2013, and corresponding to Attorney Docket No. DGRANT.003A, which is incorporated by reference herein in its entirety.

Another optional feature of this system is its ability to help avoid DNS Poisoning or DNS Redirects, sometimes also referred to as DNS spoofing. This occurs when a DNS service is compromised/hacked or a non-regulated, un-trusted DNS service is placed between the requesting URL and a valid DNS service. In response to a request from a client, DNS servers translate a human readable domain name into a numerical IP address. DNS servers often cache in memory previously obtained query results for reuse, to enhance resolution response when translating a human readable domain name into a numerical IP address. When a DNS server receives and caches a false translation, the cache is termed “poisoned”, and it will cause the DNS server to return an incorrect IP address to requesting clients, diverting traffic to the system associated with the incorrect IP address, which may be the hacker's system.

The example publisher and network registration system optionally helps ensure the content is being published from a validated source by comparing the resolved IP Address with the registered IP Address. When an invalid DNS is present, the system can intercept DNS requests, but the IP Address for the URL returned will not match the IP Address registered in the publisher and network registration service. The system will detect such a mismatch causing an error or alert condition to be generated by the system.

Optionally, the publisher and network registration system operates as an “allow” list, in which content is blocked from being presented to a user unless the publisher has been registered and the content meets any other criteria present. Optionally, the publisher and network registration system may be configured to operate as a “block” list, in which content is allowed to pass through to be viewed by a user unless the content has been identified by the system as impermissible. For example, the system may be configured to block all advertisements provided by a particular publisher, such as a specific ad serving service.

Certain embodiments, optionally including embodiments discussed above (e.g., the CEMS), may include a translation system that provides enhanced control with respect to managing network resource requests, as described below. An example translation system may be implemented to include one or more features, processes, and/or components described above or in the associated figures. Optionally, the translation system may be hosted and/or executed by one or more components described herein. Optionally, the translation system may be used with or independent of the CEMS. As described in greater detail herein, the translation system optionally encrypts and/or translates network references, including resource locators, such as URLs.

The example translation system, such as may be incorporated in a reference encryption and security translation system (RESTS), described herein may provide network administrators and access providers with technologies to better manage the security, delivery, content, and/or resources transmitted over networks, including their own networks. Optionally, the RESTS may also provide publishers, advertisers and service providers improved processes and solutions to secure and protect the content they deliver or provide. Optionally, the RESTS may provide dynamic routing of content based, in whole or in part, on packet-level content and/or referenced content rules as opposed to determinist transport rules (although certain embodiments may utilize determinist transport rules as well Optionally, the RESTS may enable routing to evolve from deterministic packet-level routing and transport rules to include, but not be limited to, dynamic content-based routing solutions with greater granularity and options for network operators. Optionally, the RESTS may provide any combination (e.g., some or all) of the features described herein. Employing REST technologies for Content-Based routing rules alone, or in addition to IP-Packet or other protocol-based routing rules, provides network operators and the Internet in general with new, more efficient way to route data and information. Rules based on content enables network operators to not only apply the rules more granularly based on content, but they could also conditionally redirect, substitute or re-route delivery of information based on the content being delivered. Optionally, such rules may be specified via a user interface by network operators and/or Internet access providers, and the rules may then be stored and applied via certain embodiments.

Further, as “Do Not Track” initiatives and government mandates evolve to protect consumer information from nefarious vendors or overzealous data aggregators, the RESTS optionally provides content and URL-based methods to facilitate these efforts by enabling site and/or user controlled locator translation rules to be implemented and executed. In addition to protocol routing rules which are typically managed at a more macro level, these translation rules may provide network operators and publishers with new granular solutions to address problems like periodic traffic congested based on content rather than simply protocol. For example, consider Internet traffic across a particular network segment utilizing REST, the network segment might automatically and dynamically determine whether to allow particular publishers to deliver video ads vs. image ads based on current bandwidth demand or performance rules. This approach can be analogized to rolling brown-outs performed when energy demand exceeds supply, however in this context the approach can target specific households and/or specific appliances.

Optionally, the translation system enables nodes in a network to secure reference content passing through the network or residing in network components. This technique may enhance security, and may optionally be utilized to prohibit or impede certain processes seeking to identify, modify, or remove the protected or enhanced content authorized by the network operator or access provider.

Optionally, the translation system may employ data storage enabling the substitution (e.g., the direct substitution) of identified reference content, and/or may utilize algorithms to transform and reconstruct content references dynamically, and/or may substitute tokens for identified references.

Optionally, the translation system may enable content replacement within network nodes or client software. Optionally, the translation system may use industry standard router controls to further enhance such embodiments.

Optionally, the translation system may be implemented as stand-alone software, add-on software, programming script, or firmware that may be hosted by and/or run on one or a plurality of computer systems (including one or more processing devices) connected to a network and/or via the use of dedicated hardware.

Optionally, the translation system may be used in concert with a resolution service, such as a Domain Name Service (DNS), or independently from such a domain resolution service.

For example, a DNS is commonly used to resolve logical addresses or domain names, such as Google.com, Yahoo.com or CNN.com, into a physical IP Addresses, such as 74.125.225.228, 98.138.253.109, and 165.160.15.20 respectively, via a DNS record. A simplified conventional DNS lookup process is illustrated in FIG. 9.

Although certain embodiments of the translation system may be configured to emulate the response of the DNS, certain embodiments may in addition or instead be configured to enhance the security of references (such as URLs) as they pass through the network and also within the nodes were they ultimately are delivered.

Referring to FIG. 9, an example conventional DNS resolution process is illustrated. At block 1, a user computer device issues a domain request (e.g., a URL) to a local router for a DNS record that provides the IP address for the requested domain. The request is received by the local router. At block 2, the router transmits the DNS record request to an ISP system (Internet Service Provider). The ISP system receives the DNS record request. At block 3, the ISP system asks a Root Server (e.g., corresponding to the top level domain in the request) for a Name server providing responses to queries against a directory service. The Root Server receives the request for the Name server. At block 4, the Root server provides the ISP system the Name server. At block 5, the ISP system requests the DNS record from the Name server, and the request is received by the Name server. At block 6, the Name server looks up the DNS record (often from a cache), and provides the DNS record to the ISP system, which receives the DNS record. At block 7, the ISP system transmits the DNS record to the router, and the request is received by the router. At block 8, the router provides the user computer device with the DNS record. After the DNS record is resolved at step 8, it then attempts to contact the address represented in the DNS record directly. For the purpose of illustration, consider an example where a user types the URL address of http://www.my-Desired-Domain.com into an Internet browser's address bar.

In this example, once the user submits this request (e.g., by pressing an Enter key), the user browser transmits a DNS Lookup request to the DNS server. In this example, a simple DNS topology is assumed, whereby the resolution request is found at the first DNS Server and the DNS record is returned to the user's terminal with the resolved Internet or IP address.

The user's terminal or browser next attempts to communicate with the Internet device residing at the IP address returned in the DNS Lookup Record. For simplicity, it is assumed in this example that the URL address requested and IP address returned by the DNS Lookup process is represented by a default web site, and when this web site is contacted using the returned information from the DNS Lookup process, the web site will return an HTML web page to the user's computer.

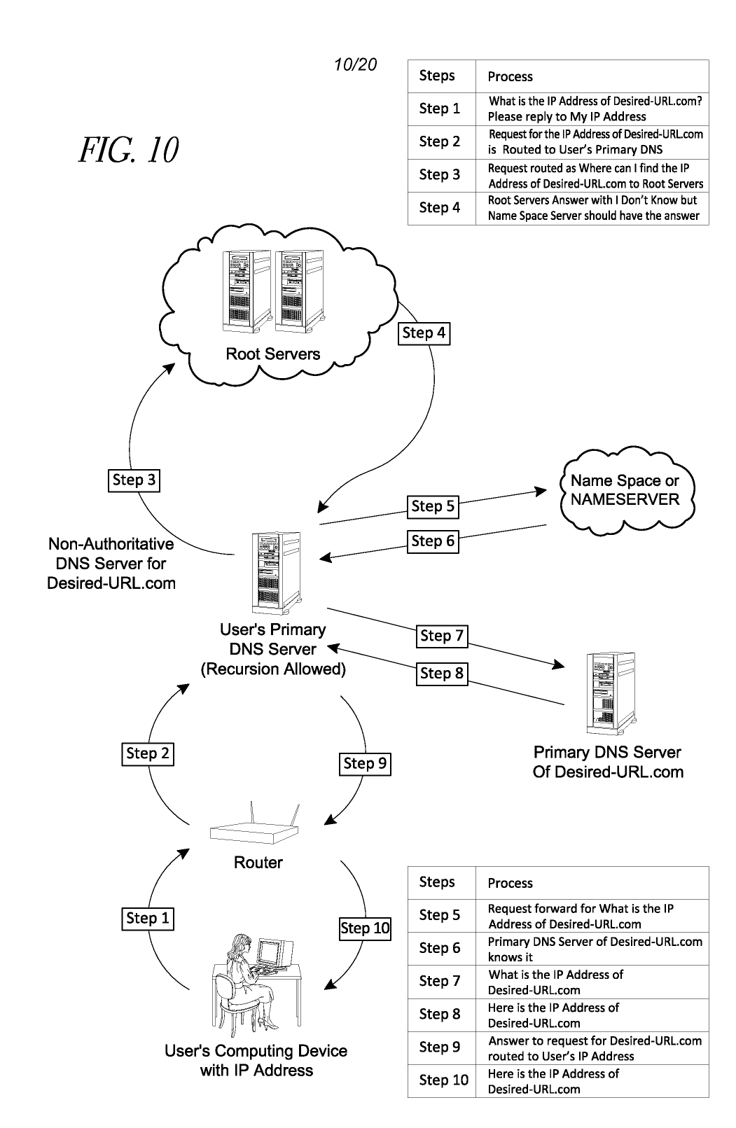

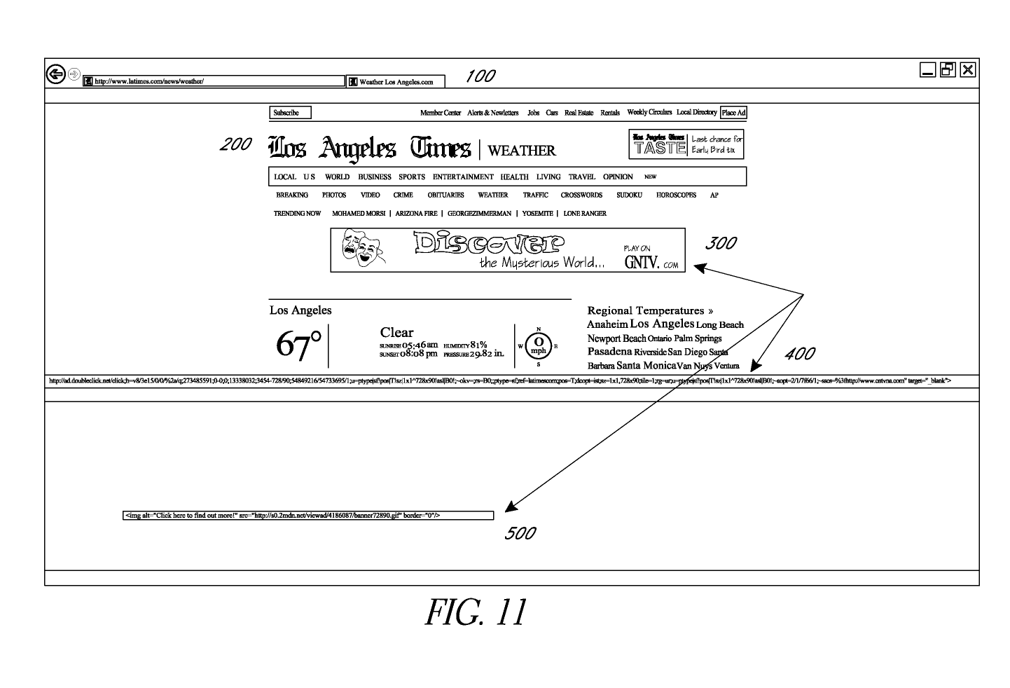

FIG. 10 illustrates a more complex conventional DNS process, with substantially the same result as the process illustrated in FIG. 9. At block 1, a user computer device issues a domain request (e.g., a URL) to a local router for a DNS record that provides the IP address for the requested URL, wherein the requests asks that the reply be provided to the user computer device's IP address. The request is received by the local router. At block 2, the router transmits the DNS record request to the user's primary DNS. The DNS receives the DNS record request. At block 3, the user's primary DNS asks the Root Server(s), where the DNS record (the IP address of the desired URL) can be located. At block 4, the Root Server(s) responds that the Root Server does not know where the DNS record is located, but that a specified Name Server will know where the DNS record is located. At block 5, the user's primary DNS issues the request for the DNS record to the specified Name server/Name space. At block 6, the specified Name server/Name space responds to the user's primary DNS, indicating that the primary DNS of the desired URL knows the IP address for the URL. At block 7, the user's primary DNS issues a request for the DNS record to the primary DNS of the desired URL. At block 8, the primary DNS of the desired URL responds to the user's primary DNS with the IP address corresponding to the requested URL. At block 9, the user's primary DNS transmits the IP address corresponding to the requested URL to the router. At block 10, the router provides the user computer device with the IP address corresponding to the requested URL. The user computer device can request the page corresponding to the IP address, and the server hosting returns the page (comprising HTML code, JavaScript, etc.) to the user computer device.

Now that the page is returned to the requesting device, the HTML represented within the page may include many references and links to other HTML pages, embedded content, objects, advertisements, images, videos and/or script. HTML that can be inherently displayed, such as HTML text, is normally displayed on screen, however, images and other objects are often retrieved into the displayed page using separate URL references.

To illustrate this by way of example, FIG. 11 illustrates a screen capture of a newspaper (LOS ANGELES TIMES® in this example) weather page (200) at the URL address:
“http://www.latimes.com/news/weather/” (100).

In the middle of the page is a banner ad advertisement (300) with text “Discover the Mysterious World . . . ”

The image representing this banner ad (300) in FIG. 10 is derived from the HTML Image Tag (500) shown below and was retrieved using the “src” attribute of the image tag (500) from the source URL shown below.
<img alt=“Click here to find out more!”src=“http://s0.2mdn.net/viewad/4186087/banner72890.gif” border=“0”/>

### URL 500

It is clear that the page domain URL (100) of “latimes.com” and the advertisement's image source URL (500) are different.
http://s0.2mdn.net/viewad/4186087/banner72890.gif

### “Src” Attribute of the Image Tag (500)

Additionally, the event or action executed by clicking on this banner ad (300) is controlled by the link or HTML Anchor Tag (400) shown below. In this scenario, the HTML Click Event referenced by the ad (300) would attempt to connect with the root domain represented herein “http://ad.doubleclick.net” (400) and likely record or attempt to capture the meta data implied by the long URL query string (400), such as the page URL, the article reference, page specific values, and destination link or page referenced by the URL “http://www.cntvna.com”. Note that in this real example, the domain addresses for “latimes.com” (100), the ad display URL (300 and 500) of “2mdn.net”, and the ad server action or HTML Click Event URL (400) of “doubleclick.net” all have different root URLs that resolve to the different physical IP Addresses 163.192.187.17, 74.125.227.91 and 70.32.146.212 respectively, which are very often un-discoverable to the public or network operators.

Link (400)
<a href=“http://ad.doubleclick.net/click;h=v8/3e15/0/0/%2a/q;273485591;0-0;0;13338032;3454-
728/90;54849216/54733695/1;u=ptype|sf!pos|T!sz|1x1\hat{ }728x90!asl|B0!;^{~}okv=;rs=B0;;ptype=sf;ref=latimescom;
pos=T;dcopt=ist;sz=1x1,728x90;tile=1;rg=ur;u=ptype|sf!pos|T!sz|1x1\hat{ }728x90!asl|B0!;^{~}aopt=2/1/7f66/1;^{~}sscs=%
3fhttp://www.cntvna.com” target=“_blank”>

By way of this example, it is shown that many of the references within the website page requested are actually retrieved or linked to URLs other than the page URL itself. Similarly, web pages can deliver programmatic script that is regularly executed by third party content providers not requested or desired by the user or network access provider. These facts make managing ad content, burdensome bandwidth utilization, and reference security challenging for network providers and consumers.

Some users and network operators conventionally attempt to block these third party references using ad or script blockers to avoid unwanted or potentially harmful content, and often network access providers attempt to selectively block or deny this type of content because it is often untrusted and can require significantly more bandwidth and resources to process, which can negatively impact other users. By way of illustration, when several users connect to the Internet at a public access point they share the available bandwidth from that access provider. Simple web pages are typically very small in size and do not typically impact user experience. By contrast, images can be orders of magnitude larger than a complete page of text, and videos and large download files are regularly several orders of magnitude larger than such images. As a result, even one user accessing video content on a public access point can significantly degrade the experience for all users sharing that bandwidth.

For this reason, many access providers block certain URLs and/or protocols, or purchase expensive equipment that can limit bandwidth by user to preserver the experience for all users and protect unauthorized content from entering their networks. Without the granularity to control or block burdensome bandwidth at a content-level, network operators are often forced to make tough and sometimes unpopular macro decisions to block access based on domain URLs or protocols, such as by blocking common video streaming sites, such as YOUTUBE®, HULU® and NETFLIX®.

In addition, the distribution of advertisements found in many web pages can consume a significant amount of network bandwidth and may also include scripts that can secretly capture potentially sensitive information about the user or the network provider's infrastructure without the permission of the user or the network provider. In many cases this collection is performed by Internet computers located outside the country where the webpage is hosted, creating additional securities concerns about what data is captured, where such data is stored and how such data is used.

These trespasses are traditionally accomplished without the network provider's permission and without compensating the access provider for the infrastructure services they provide that enable the delivery of such third-party content, advertisements, or script. Knowing this risk, many network providers simply and inadequately disclose the risk to their users, since there have been no adequate technologies to help conditionally manage costs and content.

To help address the burdensome bandwidth issues, some network providers charge for access as a way to monetize their service and offset the cost of the equipment they provide. However, increasingly, consumers expect free Internet access everywhere. Compounding this trend for free access is the fact that ever larger numbers of users are accessing the Internet from more locations, on more devices, and consuming significant larger bandwidth and content. This exponential growth of access is multiplied by the exploding demand for burdensome bandwidth from third-party content is driving connection and bandwidth costs higher, requiring network operators to upgrade their infrastructure to service this explosive demand for free, fast access.

To address these issues, some network providers are looking for new ways to monetize their networks though shared advertising models. One such model is for the access providers to redirect users to a controlled landing page when they first open their browsers regardless of the URLs requested. The landing page has been conventionally used to capture payment for access before the user is permitted access to the Internet and often as a destination page for branding and information about the service being provided. However, with the growing demand for free access network providers are attempting to use landing pages for advertisement revenues.

Unfortunately, these conventional solutions are fragmented, and small network operators typically do not have the resources or the volume to monetize these pages adequately. Allowing advertisers to dynamically compete for landing page presence may increase demand and aggregate revenues, however, with limited tools available to network operators and the lack of content-level routing rules, attempting to filter or limit user access based on solely on advertiser URLs and content prerequisites is technically overwhelming for many network operators to manage using conventional approaches.

Conventionally, to permit advertisers to compete, network operators often must manage an Access Control List that enables advertisements to be delivered into their network while not allowing the user access to the Internet or other networks until the landing page has been successfully monetized. These lists are often very binary based on a few routes and typically base their rules on device IDs rather than content.

Conventionally, managing Access Control Lists based on dynamically served advertisements from a variety of distributors in real time creates a significant problem for network operators because the network operators may need to predict all possible paths a user could access for each advertisement or link beforehand. Alternatively, the network operator could provide root level domain access for each possible advertiser in the Access Control List, but there are millions of advertisers and thousands of ad servers, making this approach very challenging as well, and impractical to implement.

Further, the difficulty of this task is compounded by the practice of advertisers providing links to online shopping sites, where the advertisers are hoping the user clicking on their advertisement will link to a site where the user can purchase the advertised item or service.

Consider the complexity of the following example where a user is presented with an advertisement and the opportunity to link to a shopping site where the user could purchase the advertised item online. If the Access Control List did not already include this link to allow for navigation to the shopping site URL, that link would fail, and the user and advertiser would likely both be disappointed by the missed opportunity for the user to purchase the advertised item. Assuming the URL link was previously permitted, then the user would be allowed outside the network provider's landing page to the destination online shopping site to purchase the advertised item. However, as with many online shopping sites today, once the user has navigated on the Internet and accessed a shopping cart, they would likely be presented with many additional links that might include a user login link, links to other similarly purchased items, links to ratings and comments from others who had purchased this item, links to information or specification about the advertised item, email links for support or service, and many more links. Simply adding other items to the online shopping cart might exponentially increase the number of available links the user might follow. Further, this simple example does not address the fact that many advertising and shopping URLs are dynamic and change with time, user cookie and location, or that many sites include links to other sites making, making the challenge of creating access control lists astronomically complex.

Equation 1 is an illustrative equation that demonstrates how large the number of entries in an Access Control List could be with just a few advertisers.

$${\sum }_{i = 0}^{i} {( {l}_{i} \cdot {p}_{i}^{{e}_{i}} )}^{{t}_{i}} \qquad Equation 1$$

If each of these links were not already included in the Access Control List, each time the user attempted to click on one of these available links the navigation would fail, or the user would likely be redirected to back to the landing page.

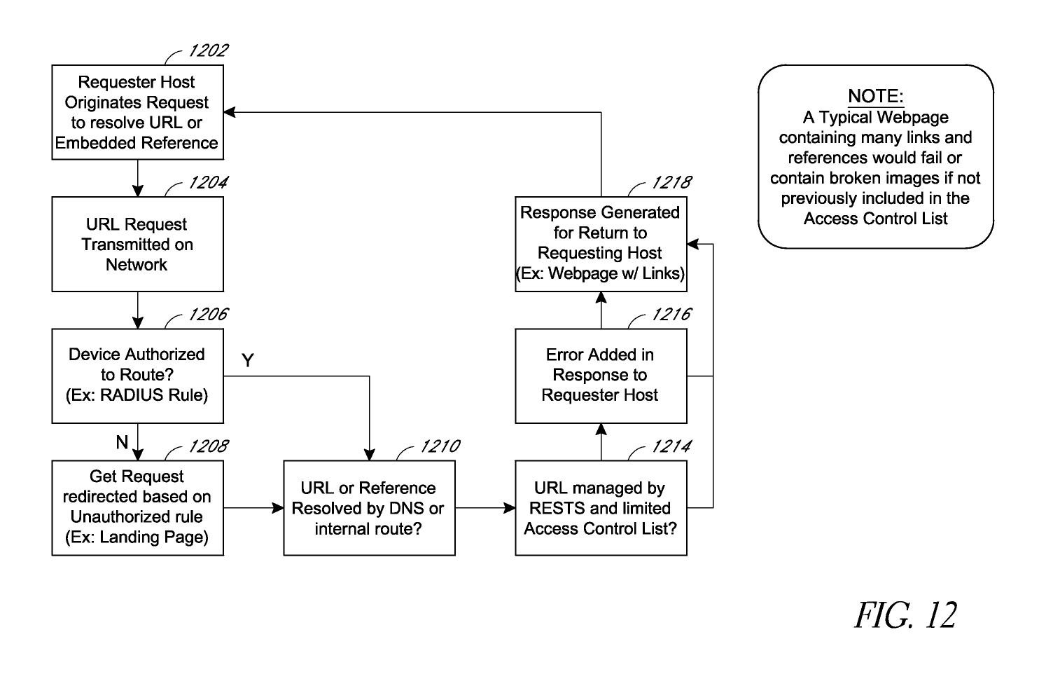

FIG. 12 demonstrates how a simple failed link/request workflow may regularly and frustratingly force user back inside the network when links are missing from an Access Control List, are not previously known, or are dynamically changing. At block 1202, a requesting host (e.g., a user computer device) originates a request to resolve a URL or embedded reference. At block 1204, the URL (or embedded reference) request is transmitted over a network (e.g., a local network of a WiFi hotspot provider, such a store, hotel, restaurant, etc.). At block 1206, a determination is made by a network component as to whether the requesting component is authorized to route the request (e.g., using a Remote Authentication Dial-In User Service (RADIUS) rule, where RADIUS is a networking protocol providing centralized Authentication, Authorization, and Accounting (AAA) management for users that connect and use a network service). If it is determined that the requesting host or network component is not authorized to access the requested URL (or reference) over the network, at block 1208 the host request is rerouted to another page (e.g., a landing page or error page). If, at block 1206, it is determined that the requesting host or network component is authorized to access the requested URL or reference over the network, at block 1210, a determination is made as to whether the URL or reference can be resolved by the DNS or an internal route. At block 1214, a determination is made as to whether the requested URL or reference is already managed in an access control list, and if so, at state 1218, a response (e.g., the webpage corresponding to the request, with embedded links) is generated for return to the requesting host. If, at block 1206, it is determined that the requesting host or network component is not authorized to access the requested URL or reference over the network, at block 1216, an error message or indicator is added to the response to the requesting host, and at block 1218, the response (e.g., including a webpage with failed links or broken images), is returned to the host.

With this example, it becomes clear how Access Control Lists may become unmanageable for network operators seeking to allow advertisers to compete for space on their landing pages. Some large operators with enough volume simply do not allow advertisers to link and may instead host micro-sites for these advertisers inside their own network (an intranet) so the user can link or transact on a specialized, controlled internal site—not on the Internet. This approach is relatively rare, but large private network operators can effectively monetize this solution which is not available to the many, many smaller network operators because they lack both the abilities of very large private network operators and a technology such as that provided by certain embodiments of the translation system described herein.

The inability to manage URL reference links or burdensome bandwidth content on their own networks have limited the opportunity of access providers to share in Internet revenues that could help offset their costs and enhance security to offer users with safer and improved services.

The translation example system described herein may optionally address some or all of the problems described above, without requiring the management of unwieldy large Access Control Lists and/or the blocking unwanted content. By transforming references, such as URLs, based in whole or in part on site and node specific rules, enhanced methods are provided for addressing certain problems discussed above.

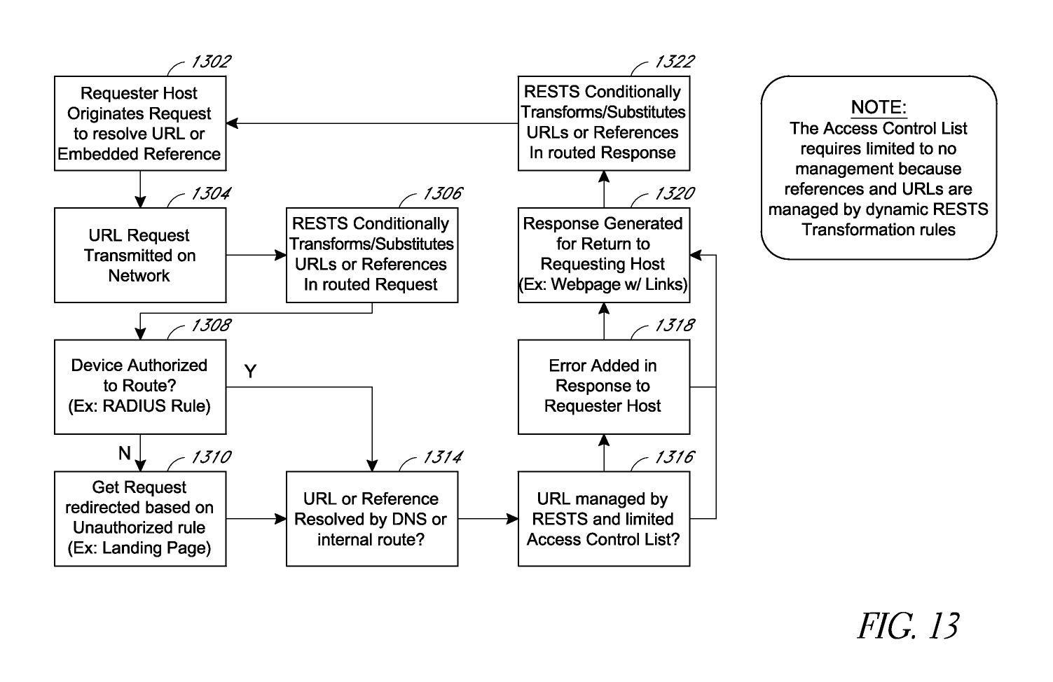

FIG. 13 illustrates an example process incorporating such a translation system. As illustrated in FIG. 13, if the translation system (e.g., the RESTS translation system) is utilized, responses to requests are routed to the translation system which conditionally transforms the reference and performs direct object substitution, and the transformed request is returned to the user device.

Optionally, the translation system may include one or more of the following features:
Dynamically manage a list of allowed references (wherein a list may be any data structure), such as URLs, such that allowed URLs may be transformed to permit only the transformed URLs to pass between networks
Dynamically manage a list of allowed references, such as allowed URLs, such that a set of valid URLs would be transformed into tokens that could be used by other rules or processes to manage access between networks or to preferred network destinations
Dynamically mange a list of disallowed references, such as disallowed URLs such that the set of disallowed URLs would be transformed into unresolved physical addresses or tokens that could be ignored or used by other rules and processes
Dynamically manage a list of references, such as URLs, such that these URLs may be transformed to resolve into other addresses without affecting the DNS structure
Dynamically manage reference resolution, such as URL resolution, within a new process separate from the primary, secondary or previously assigned DNS
Bypass ad blockers or content recognition algorithms, and enable the network providers to monetize advertising on their landing pages or other pages on their networks
An advertising substitution solution to enable enhanced network advertising

For example, consider landing pages that include network provider sponsored ads or ad tags which might be integrated to help subsidize free Wi-Fi Internet access. Users opting to use this network for free might also have ad blockers installed. Theses ad blockers might search for the URLs, script, ad content, ad tags, or domains such as “some-arbritray-ad-server.com”. The ad blocker might then attempt to alter, impede or otherwise block the ad content or reference to avoid receiving ads.

Optionally, the translation system dynamically transform references, such URLs and page references, into tokenized references or URLs that would otherwise fail if not processed by or through the translation system for translation back to the URL or page reference. For example, consider a webpage that includes a reference URL to the example ad server “arbitrary-adserver.com”. For the purpose of illustration, the following are some, but not all, examples that demonstrate how the translation system might transform the original URL of “arbitrary-adserver.com” into a token for further processing. The domain reference “arbitrary-adserver.com” may then be;
Reversed to become “revresda-yrartibra.com”
Alternated inward to become “raervbrietsrdaar-y.com”
Randomized using characters to become something like “i8y5Upm4NzkR9LejbQ.com”
Randomized or tokenized with valid and/or non-valid URL characters to become something like “@:R/?94̂&a:;+w#p$>Lb!”

Thus, the above example illustrates the use of letter reversal, alternation, randomization, and/or character insertion to transform a URL. It is understood that these are just examples of transformation techniques and are not intended to limit the possible transformation techniques that the translation system may employ to protect content and/or provide value to the network operators and users opting to use their services. For example, private/public encryption keys may be used to encrypt and transform URLs.

Once example references, such as URLs, requested on the network are transformed by the translation system, the transformed URLs would fail to be resolved by DNS Lookup services into Internet addresses unless acted upon again by the translation system. That is, the transformed references would be unresolvable by DNS Lookup services in the absence of further processing by the translation system, because the DNS Lookup services would not have registries including a mapping of the transformed references to an IP address. This may enable network operators to better manage content and reference activations permitted on their networks and it may impede or prohibit other, third party scripts or programs from identifying or acting on the transformed references to attempt to block, replace or otherwise alter content referenced by the transformed URLs. The example translation techniques may also be used to conditionally allow content based on known or trusted rules.

Another optional feature enabled by the translation system is the dynamic substitution of non-relevant and/or inappropriate images. For example, the translation system may transform an original image source (e.g. <img src=“original_ad_source_URL.jpg”>) into a new source (e.g. <img scr=“network_ad_source_URL.jpg”>) without having to modify the entire advertising tag that represents this object. This substitution or transformation may be performed on a node while the reference is passing through the node, or by a module residing on the node receiving the content as an end destination.

Another optional feature enabled by the translation system is the substitution of referenced objects, such as those that might be cached on nodes with alternate network objects such that no transformation to the page reference is necessary. The resolution and delivery of such referenced objects may be managed in substantially real-time using the system.

The example process illustrated in FIG. 13 will now be described in greater detail. At block 1302, a requesting host (e.g., a user computer device) originates a request to resolve a URL or embedded reference. At block 1304, the URL (or embedded reference) request is transmitted over a network (e.g., a local network of a WiFi hotspot provider, such a store, hotel, restaurant, etc.). Unlike the example illustrated in FIG. 12, at block 1306, the reference encryption and security translation system (RESTS) receives the request and conditionally transforms and/or substitutes URLs or references in the request. For example, the URLs or references may optionally be tokenized. As similarly discussed herein, optional example transformation techniques may include letter reversal, alternation, randomization, character insertion, and/or encryption using private/public encryption keys. Optional example substitution techniques include the substitution of image or object references with different image or object references.

At block 1308, a determination is made by a network component as to whether the requesting component is authorized to route the request (e.g., using a Remote Authentication Dial-In User Service (RADIUS) rule, where RADIUS is a networking protocol providing centralized Authentication, Authorization, and Accounting (AAA) management for users that connect and use a network service, or using the Diameter protocol, or other protocols). If it is determined that the requesting host or network component is not authorized to access the requested URL (or reference) over the network, at block 1310 the host request is rerouted to another page (e.g., a landing page or error page). If, at block 1308, it is determined that the requesting host or network component is authorized to access the requested URL or reference over the network, at block 1314, a determination is made as to whether the URL or reference can be resolved by the DNS or an internal route.

At block 1316, a determination is made as to whether the requested URL or reference is managed by the RESTS and a limited access control list. If a determination is made that the requested URL or reference is managed by the RESTS and a limited access control list, at state 1320, a response (e.g., the webpage corresponding to the request, with embedded links) is generated for return to the requesting host. If, at block 1316, it is determined that the requesting host or network component is not authorized to access the requested URL or reference over the network, at block 1318, an error message or indicator is added to the response to the requesting host, and at block 1320, the response (e.g., including a webpage with failed links or broken images), is returned for transmission to the host. At block 1322, the RESTS conditionally transforms and/or substitutes URLs or references in the routed response. The response is then returned to the requesting host. Advantageously, the access control lists requires relatively limited or no management because the URLs and references are managed using dynamic RESTS transformation rules.

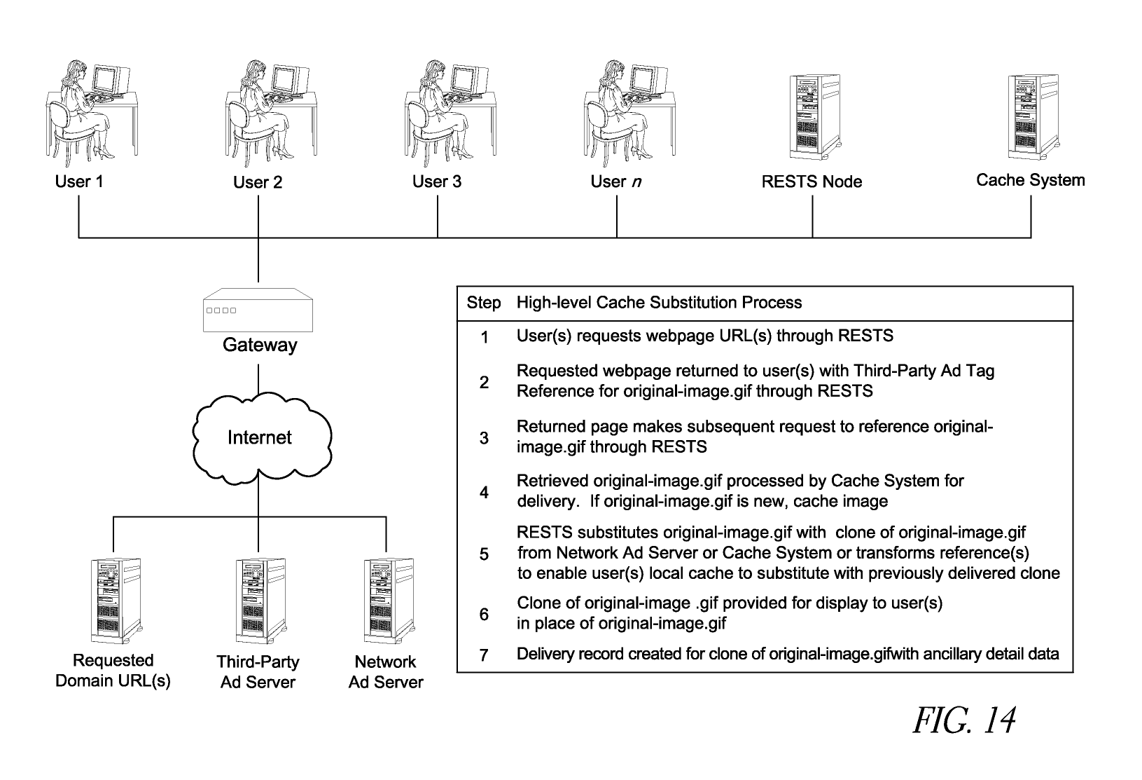

Referring now to FIG. 14, FIG. 14 illustrates an example process illustrating how the translation system optionally enables direct substitution of a reference, object, image, content and/or script by leveling system or network cache and using its conditional, content-level transformation and substitution technology.

In this example, a webpage referencing a previously cached ad object, such as an advertisement image or ad tag within a webpage, may be substituted by the RESTS translation system with a similar cached ad object or reference, or with an ad object or reference retrieved from a network ad server in substantially real time. If the originally referenced webpage object is not already cached, the translation system may substitute the original object or reference with the network operator's preferred/selected object or reference in a real-time caching and substitution process. The translation system may also leverage a user's local cache in a similar way by leveraging reference transformation services to position the substitute object in the local cache and then employ reference transformation to effect the substitution of the intended object with the network operator's preferred/selected object. For clarity, the term object may be an image, advertisement, ad tag, content, another reference, embedded object, or script.

For example, referring to FIG. 14, at state 1, the user requests a webpage URL(s) through the RESTS translation system. At state 2, the requested webpage is returned to the user with a third party ad tag reference for the original image (e.g., a gif image) through the translation system. At state 3, the returned web page makes a subsequent request to reference original image through the translation system. At state 4, the retrieved original image is processed by a cache system for delivery. If the original image is new (it has not been cached), the image is cached.

At state 5, the translation system substitutes the original image with a clone of the file, image, video, tag or object with the same or similar attributes such that when recalled by the most prevalent cache recall process the substituted file, image, video, tag or object is retrieved. In this simple, but non-limiting example, the originally requested object has the filename “image.gif”. A desired substitute object of similar display size is substituted with the filename “image.gif” or a relative reference for the original object “image.gif” such that when the cache process identified a cached object for “image.gif” exist and makes a request to retrieve this original object, the substituted “image.gif” object or relative reference to the substitute object is delivered in response and the substituted object is processed as if it were the object being requested. This substitute object for the original object from a network ad server or cache system, or the translation system transforms the reference to enable the user's local cache to substitute the original object with the previously delivered object. The substitute of the original object is provided for display by the user terminal in place of the original object.

A record of the delivery of the original object is created and stored with related detail information such as the object that was provided, the time it was activated or referenced, the device or IP address which reference it, the site or location it was referenced from and other similar information. Information regarding the substitution may be included in a report, such as those described herein. For clarification the term object referenced in the example herein may be an image file, a video file or stream, a tag, an embedded file, html script or code, a flash file, an audio file, or other such reference.

The translation system may also offer network access providers solutions to significantly simplify Access Control List management by using reference transformation to conditionally allow users to access limited Internet resources and content before full authorization to the Internet access has been granted.

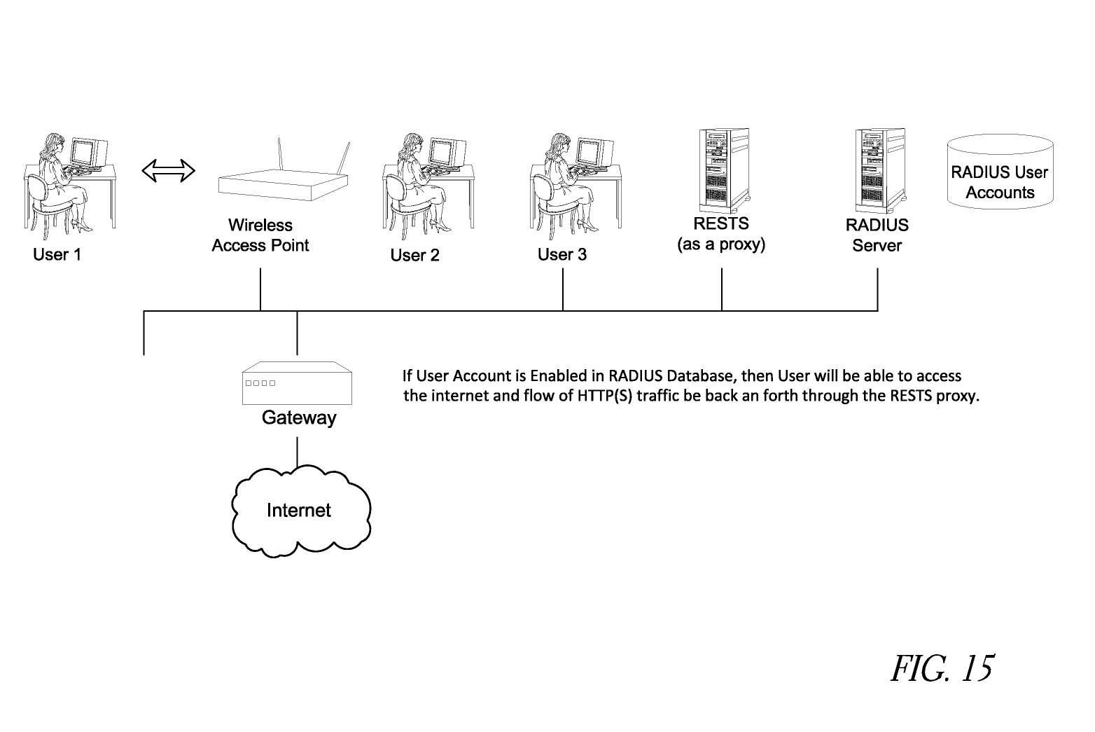

For example, many network providers use a RADIUS (Remote Authentication Dial In User Service) or other authentication and authorization solution to manage network authentication and access, as illustrated in FIG. 15. As noted above, RADIUS is a networking protocol that provides centralized Authentication, Authorization, and Accounting (AAA) management for computers that connect and use a network service. It is understood that other network authentication and access protocols, such as Diameter, may be used. Once a user is authenticated and authorized, the RADIUS (or other AAA protocol) gateway can be configured to permit the user's device to access the Internet. The challenge for network operators is that if they want to permit advertisers access on their networks, the network operators need to configure the RADIUS gateways beforehand to permit the advertiser and ad server URLs to pass through their network gateways. Similarly, if the users seeing the advertisements want to click and navigate to the advertiser's websites and potentially buy their products, the network operators would need to include these addresses in the Access Control List as well.

As similarly discussed above, this is difficult to manage because it is difficult to predict where the users might navigate within the many hundreds or thousands of links any given vendor or advertiser site may have, and the significantly larger number of possible links if the designated vendor or advertiser sites include links to other domains not hosted at their site.

For example, consider a user who is presented with an advertisement to purchase a particular book from an e-commerce site. When the user clicks on the advertisement they are linked to a shopping cart where they can purchase this book. However, the shopping cart might include a list of similar books other consumers purchased who also purchased the originally advertised book. As the user follows the links to these other books they might also encounter links to other products. These additional product links might also reference reviews and links to images not server from the e-commerce site, or possibly a logo served from a manufactures site for their product. Without knowing the multitude of URLs or possible paths the users might follow beforehand, the network operator would either have to limit the list of allowed URLs, causing the navigation to sites in this example to “break”, potentially frustrating the user and advertiser, or would need to grant the user access without granular control.

Even assuming the network operator is even able to predict all the possible links the users might follow and add them to the Access Control List, it is likely that the Access Control List would be extremely large, overwhelming to manage, and would degrade the responsiveness of the RADIUS service for other users. Optionally, the translation system use conditional URL transformation to manage the references passing by or through the translation system to dynamically control Internet access based on manageable and granular transformation rules so little or no extra Access Control List management would be necessary.

To illustrate, consider a network operator that wants to redirect users on first access to a landing page that would be dynamically populated with advertisement from various advertisers. As discussed above, in order to accomplish this using RADIUS, the Access Control List may have to include every possible advertiser reference, advertiser links and the subsequent address the users might visit. Even if there were only a few advertisers, this list is likely to be extremely large and difficult to manage manually.

However, utilizing the example translation system, individual advertising campaigns may optionally be automatically administered using transformation rules to enable dynamic navigation to sites over an operator's network using the translation system so long as they pass by or through translation system and in such optional implementation, only sites transmitted by or through translation system would be allowed on the Internet via the operator's network. If a user attempted to access another page, not yet enabled by the translation system, the user would be trapped by the RADIUS rules and would be redirected back to the landing page, or some other designated address.

By way of further example, consider the example case where a user gains access to one of many advertisers' sites via a landing page link. In this example, each advertiser listed carries 50 products and each product has 10 subpages. Each subpage includes images from a content distribution network solution where the image URLs change and a purchase option exists that links to an e-commerce web site. Each time a link fails within a page, instead of showing the user a broken link, the user is redirected based at least in part on the RADIUS routing rules.

Using the translation system, some or all references in the landing page may be dynamically transformed, and after passing by or through the translation system these references would be permitted to access the Internet.

The following is an example process utilizing the translation system to dynamically transform references. A node or other device(s) hosting the translation system are added (e.g., by an administrator) to the Access Control List to limit access requests to traverse the operator's network to only requests submitted through the node and processed by translation system. Network routes are configured to pass traffic and desired protocols to the designated node and by or through the translation system. Note that the translation system does not need to be in line with network traffic, but for simplicity of this example, the translation system is installed on a node configured in the network route. Optionally, transformation can be performed in real-time while the reference is being requested or on the node where the response was delivered.

Next, when a user opens their browser to a page or URL, having not previously been authorized by the RADIUS gateway, the user is redirected to the landing page which passes by or through a translation system enabled node. Some or all of the advertisement references in this landing page are transformed such that these transformed references will not resolve to a known Internet address or web site. Even direct IP addresses are optionally transformed so that physical navigation is inhibited as well.

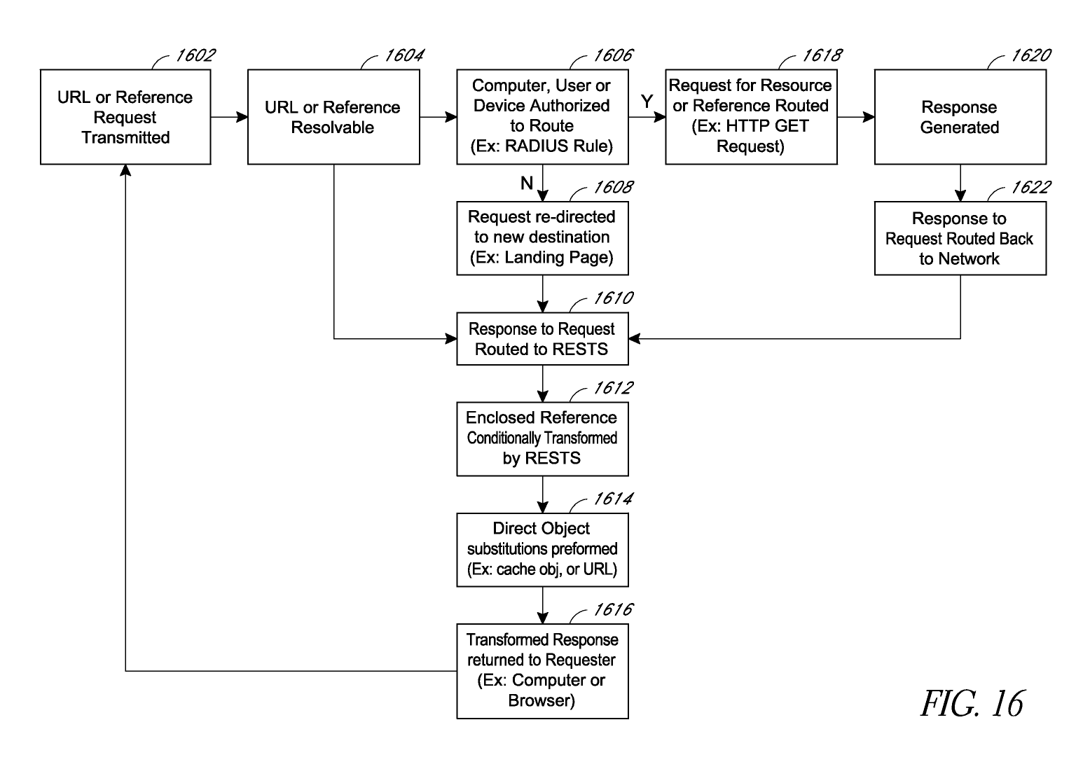

An example workflow of how a RADIUS gateway may work in concert with RESTS is illustrated in FIG. 16, although other gateways may be used in addition or instead.

At block 1602, a URL, link or other reference request, is transmitted from the user device (e.g., laptop computer, mobile phone, networked television, other terminal, etc.). At block 1604, the URL or reference is determined to be resolvable (e.g., using resolution techniques described above). At block 1606, a determination is made using an Access Control List as to whether the user device or link is authorized to route through a network operator's system (e.g., optionally using a RADIUS rule as described elsewhere herein). If the user device or link is not authorized to route, at block 1608, the user request or failed link will cause the user's browser to be redirected (e.g., to a landing page). If the user device or link is authorized to route, at block 1618 the URL or reference request is routed to the corresponding destination, at block 1620 a response is generated with many internal and external links, and at block 1622 the response is routed back the operator's network and to the RESTS translation system.

If the URL or reference is determined to be not resolvable at block 1604, the response to the request is routed to the RESTS translation system. When a request to fetch the URL address or reference is made by or through the translation system, at block 1612, the URL is transformed into a resolvable URL and navigation is permitted. Transformation may also include appending specific actionable modifiers to the URLs, such as a specialized and limited port number (e.g. URL:port), or a query string tied to an action to improve routing. Optionally, at block 1614, the RESTS translation system performs object substitution (e.g., of a cache object, URL, reference, etc.). At block 1616, the transformed response is returned to the requesting user device.

If the user attempts to submit the transformed link directly, the outbound DNS request would fail to resolve or the inbound transformation through the translation system would fail. In either case, in this example, the user would be redirected to the landing page. Similarly if the user tried to enter a valid URL, such as CNN.com, the translation system will recognize the un-transformed address and it would be ignored, or bounced back from the RADIUS workflow, or the translation system may perform the redirection as well.

If the user clicks on a valid link within the landing page or other permitted pages that were processed by or through the translation system, the outbound request would be recognized and transformed by the translation system back to a known and permitted URL. The DNS would resolve this URL, and the outbound request would be identified as passing by or through the translation system. If all the corresponding rules and conditions are met, the navigation to the destination reference site is authorized.

Using the foregoing example transformation process for other links, network operators could manage a large number of advertising campaigns and subsequent external links because the translation system could transform inbound and outbound references based on a set of rules (e.g., operator defined rules). If the user closed their browser or attempts to navigate to a page not processed by or through the translation system, the raw untransformed URL would not be recognized by the translation system and the user browser would be redirected by the RADIUS gateway back to the control/landing page.

Once the user has sufficiently met the authorization requirements, as may be specified by one or more rules (e.g., where the user needs to view one or more prerequisite advertisement(s) to be authorized and/or needs to respond to a survey presented on the user device), the system flags the requirement(s) as met using one or more techniques or mechanisms, such as one or more cookies, variables, IP addresses, and/or MAC addresses, and the RADIUS server dynamically permits access to the Internet or other designated networks based at least in part on defined RADIUS or routing rules.

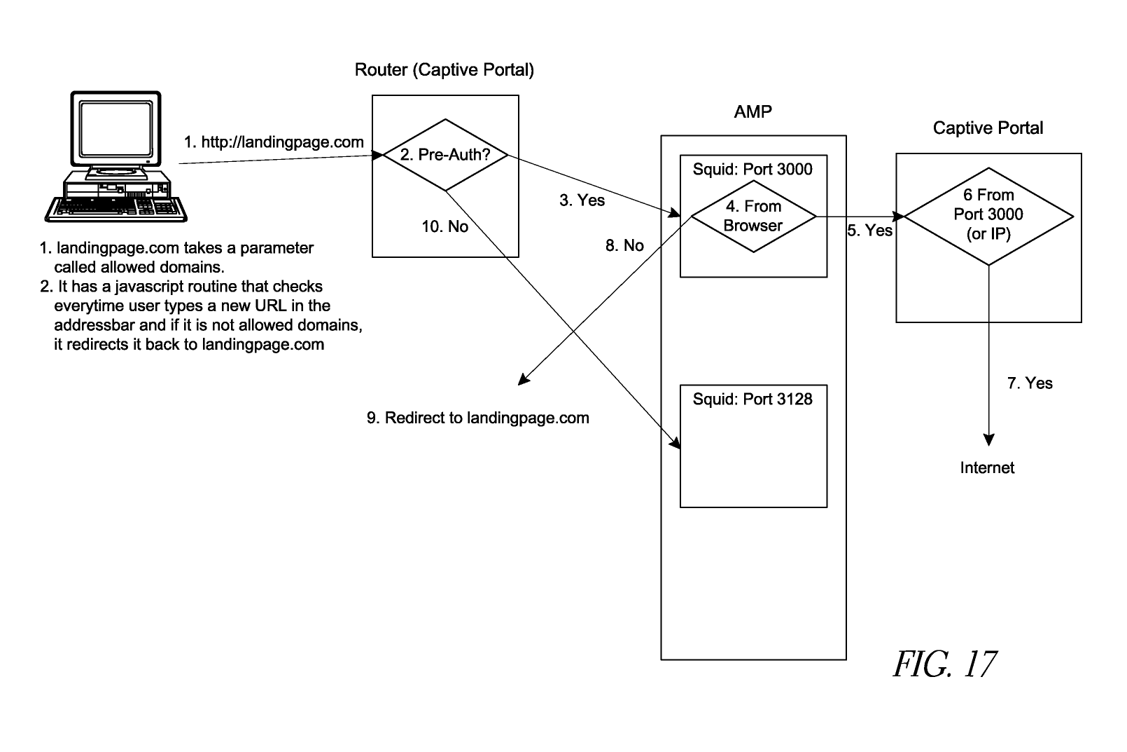

FIG. 17 illustrates an example architecture and process that utilizes a routine, such as a JavaScript routine that may have been downloaded to the user's browser when the user browser first issues a request over the operator's network, that monitors URLs entered by a user into an address field of a browser or other viewer, and if it is not in an allowed domain, redirects the user's browser to a landing page. The landing page may inform the user why the user is being blocked from accessing the entered URL (e.g., “the URL you entered is not in an allowed domain”). This technique may be used to prevent the user from browsing to a domain other than a landing page domain in the landing page, optionally without utilizing injection. Thus, at state 1, an interface receives a parameter, termed “allowed domains.” At state 2, a routine monitors URLs entered by a user into an address field of a browser or other viewer, and if it is not in an allowed domain, redirects the user's browser to a landing page. If the URL is in an allowed the domain, at state 3, the request is provided to a caching proxy. If the caching proxy determines, at state 4, that the request from the browser is not permitted (8), the browser is redirected to a landing page, at state 9. If it is determined that the browser request is permitted, the request may be routed (e.g., via a captive portal at state 7), to the Internet.

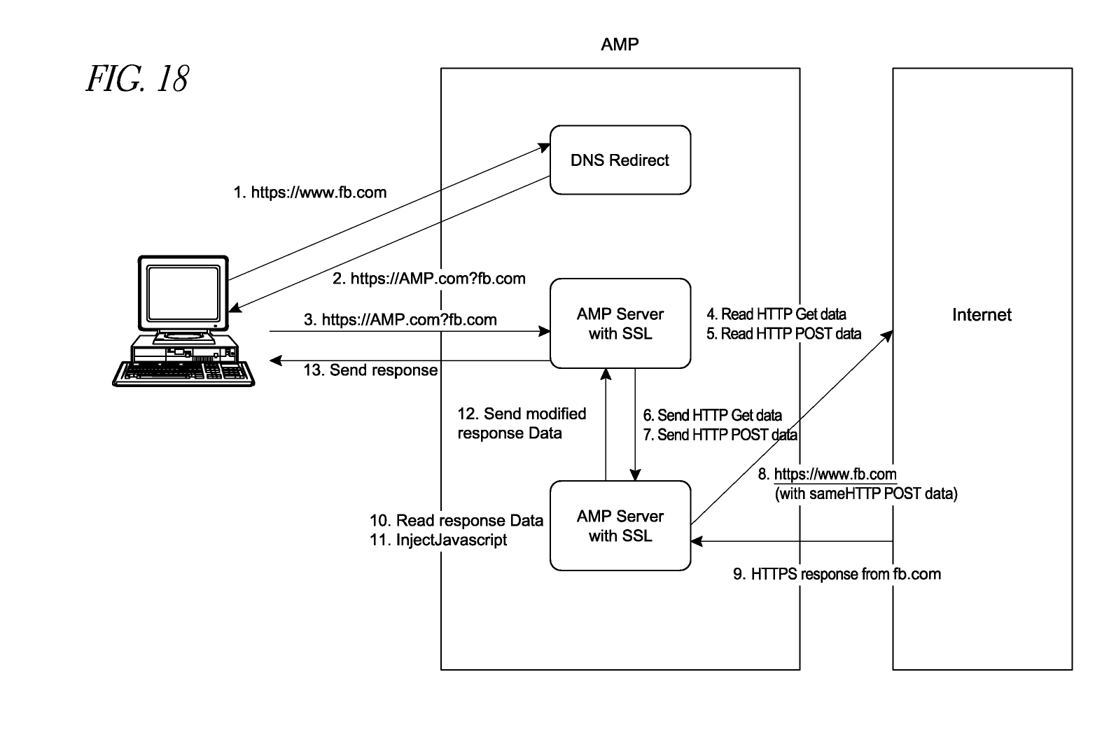

FIG. 18 illustrates an example architecture and process that utilizes a routine to monitor URLs entered by a user into an address field of a bowser or other viewer, and routes the request through an intermediary before passing the request to the Internet. This enables inspection and insertion (e.g., JavaScript insertion) while maintaining SSL encryption. The URL request is redirected via DNS redirect so that, for example, a request for https://www.fb.com is redirected to https://AP.com?www.fb.com. The server (e.g., an AMP (Apache, MySQL, Perl/PHP/Python) server) with SSL receives the redirected request, reads HTTP Get data and HTTP POST data and sends them to the client with SSL, which then accesses the Internet. Web site data, for example from https://www.fb.com, is received by the client, which reads the response data, and optionally modifies it (e.g., injecting JavaScript), and sends the modified response data to the server, which then transmits the response to the user.

While certain embodiments include a RADIUS solution, other embodiments need not include the RADIUS solution. Other redirection and routing solutions may be used to enable the translation system to transform references and content and offer network operators conditional control over the links, script and other content that might be permitted on pass through or over their networks.

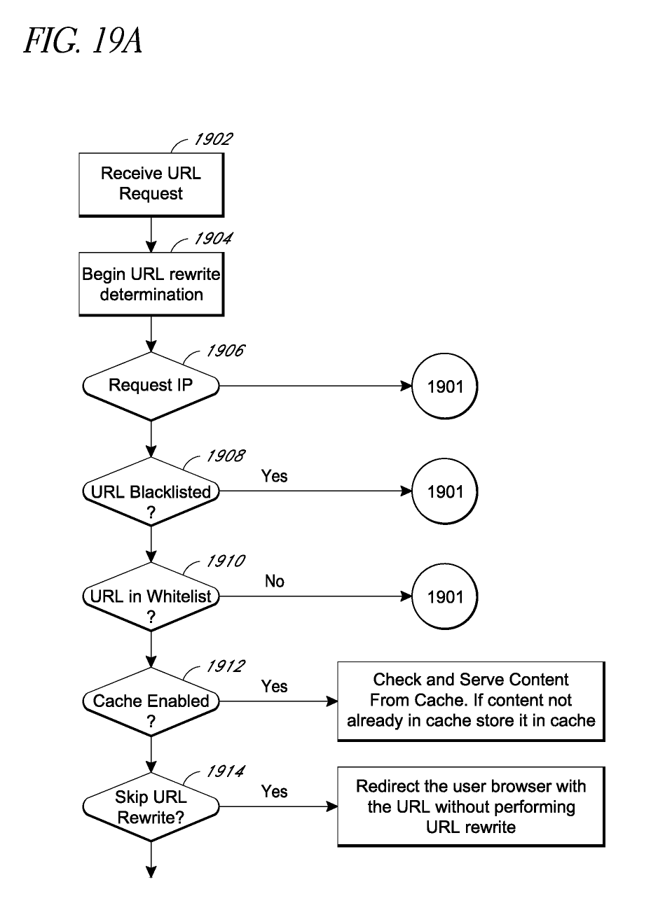

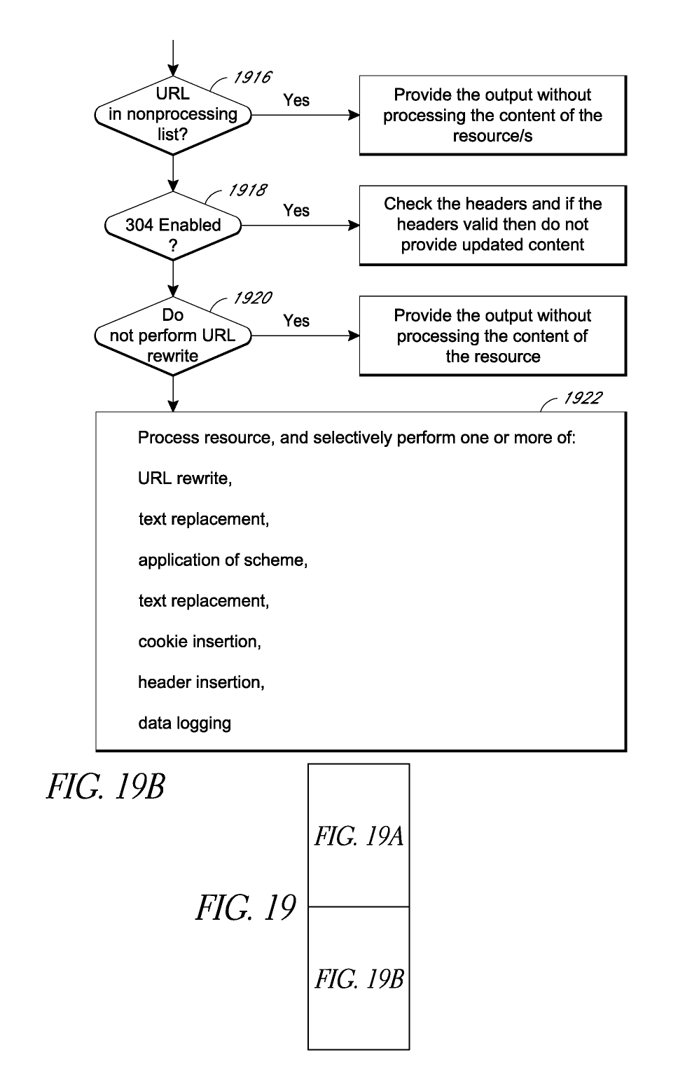

Following is a description of an example process for selectively rewriting URLs using a rewrite engine (which may comprise all or portions of the RESTS), with reference to FIGS. 19A-B. The URL may be included in a request from a client device, where the client device is trying to transmit the request from a first network (e.g., a local network of an entity, such as a hotel, restaurant, store, mall, workplace, etc.) to a second network (e.g., the Internet). The process may be executed in whole or in part by a system, such as a URL redirection engine, optionally operated by an entity different than the entity operating the first network. For example, the first network operator may contract with the URL redirect engine operator to supply the URL redirection services described herein. The URL redirect engine may be configured to selectively permit certain URL requests to be granted (e.g., only one or more specific URLs or no URLs), and certain URL requests to be denied. In certain cases, the URL redirect engine may rewrite the URL so that it is directed to a web server different than that requested, and the web server may selectively access the requested URL and provide the corresponding content to the client device. Thus, the rewrite engine may act as a proxy bridge between the client device and the Internet, but to the client device it appears that the Internet is being freely accessed, even though access is being regulated by the URL redirect engine.

Optionally, the rewrite engine or an associated system may host content as a proxy on behalf of the network or an advertiser. This enables the network operator to create or have created a walled garden service, enabling a high degree of selectively with respect to requests transmitted to destinations outside the network operator's network and with respect to content being received by the network operator's network from other networks (e.g., from the Internet). Further, the rewrite engine optionally provides a rapid and intelligent mechanism to manage whitelists and/or blacklists based at least in part on advertisement campaigns.

The rewrite engine may be configured to selectively apply different rules to a URL (or other reference) request and/or response based at in part on one or more of the following criteria:
the content being requested and/or being received (e.g., the format of the content, the code-type or content-type included the content (e.g., HTML, JavaScript, CSS, FLASH, images, URLs, etc.), the subject matter of the content, text or images included in the content, etc.);
the URL (or other reference) being requested;
the location of the requesting device (e.g., based on the IP address, user provided location information, network operator provided information, etc.).
he rewrite engine may optionally be configured to processes one or more of the following content-types and/or other content:
   HTML
   JavaScript
   CSS
   Flash
   Images
   Video (e.g., VAST)
   SGML
   XML
   TXT
he rewrite engine may optionally be configured to apply one or more of the following meta rules:
   Client IP address (e.g., allow/disallow access based at least in part on the client IP address);
   Destination URL (allow/disallow access to destination URL (e.g., based on its presence or absence from the whitelist or blacklist));
   Host Schema (e.g., HTTP/HTTPS/FTP, FTPS, SFTP, Auto (e.g., where for references (e.g., URLs) that are to be rewritten, the URL engine rewrites the reference and applies the appropriate schema specified by the requesting device (e.g., HTTP, HTTPS, FTP, FTPS, SFTP, Auto, etc.));
   Skip Processing (e.g., an indication that the request is not to be modified or processed by the rewrite engine);
   Non-processing (e.g., a flag stored in association with the reference (e.g., URL) being requested (e.g., in a table of references being maintained by the rewrite engine) that indicates that the reference being requested should not be processed);
   Cookie modification (add, enhance (modify the cookie content (e.g., modify the date stored in the cookie, read the cookie to understand experience and change the experience delivered, etc.)), or remove a cookie);
   Header modification (add, enhance (e.g., modify the header to change how the data refreshes or otherwise changes the header), remove a header); by way of illustrative example, a header may be added or modified to identify what server the content is coming from, or to identify if the content came from a rewrite engine cache or from the website corresponding to requested URL;
   Inject Code (e.g., HTML, JS, Image, Flash, JS) (e.g., add, enhance, remove code); by way of illustrative example, any type of code may be optionally injected, such as to change what will be displayed to the user (e.g., to change the <body> text content in content being accessed and provided to the requesting client);
   URL (e.g., enhance/modify the URL to point to a different destination to provide URL masquerading (e.g., http://application.mediashift.net/www.example.com may be, on the fly, changed to http://application.mediashift.net/www.cnn.com)
   Cache (turn on or turn off (optionally the cache, such as a content cache, may be turned on by default, or optionally the cache may be turned off by default).

The rewrite engine may be configured to applies business processing rules based on any combination of the content categories (such as those discussed herein) and meta rules (such as those discussed herein), to provide much greater and more complex control of content and network access as compared to conventional proxy systems.

By way of illustrative example, the rewrite engine may be configured to process a request and content as follows:

1. All HTML pages that are coming from destination URL “CNN.com” are permitted to be accessed from the Internet over the network operator's network for the following (Client IP addresses) 1.1.1.1 and are to be cached.

2. Specified code is to be injected on all destinations URLs that are of the type finance.cnn.com

As compared to a convention proxy system, the URL rewrite engine offers one or more of the following optional advantages:
a client device requesting a URL does not need to be specifically configured to access and utilize the URL rewrite engine, and special software does not have to be installed on the client to configured to access and utilize the URL rewrite engine, yet the client device can access and utilize the URL rewrite engine on-demand (unlike a conventional proxy);
a conventional proxy requires the requested URL go through the proxy. By contrast, the URL rewrite engine optionally enables the client device to access the URL (and associated end point and resources) directly;
the URL rewrite engine enables the masquerading of content and hosting of webpages in differing ways;
webpages corresponding to a domain or subdomain may be re-hosted by the URL rewrite engine, in its memory space, and can be accessed via a URL, as opposed to merely acting as a conduit for passing traffic.

The URL rewrite engine may optionally add, remove, and/or modify various elements (e.g., content on the page, cookies, headers, etc.) individually or any combination. The URL redirect engine may optionally inject, remove, modify or transport cookies onto the client device on behalf of the web site that corresponds to the requested URL, control how many cookies and which cookies may be passed between the website and the client device. As noted above, optionally, the URL redirect engine may customize and inject headers associated with the requested content.

Referring to FIGS. 19A-B, at block 1902, a request is received by the URL rewrite engine. The URL request may be from an end user browser hosted on a client device, from a web service or other source. For example, the URL may have been entered into a browser address field, may be from a link in a webpage, or otherwise. A local network may be configured to direct some or all URL requests to the URL rewrite engine. By way of illustration, if the requested URL is https://Acme.com, the request may be directed to http://mlife.mediashift.ne/Acme.com (where mlife.mediashift.ne may be a domain associated with the URL rewrite engine operator). At block 1904, the URL rewrite engine begins the determination as to whether a URL rewrite is to be performed. At block 1906, optionally a determination is made as to whether the client device is permitted to access the network. For example, the URL rewrite engine may determine whether the MAC address of the client device is on a list of permitted devices to access the network's router. If the client device is not permitted to access the network, the user is so notified. For example, an HTTP 404 error message may be transmitted to the client device, or the client device may be redirected to a landing page associated with the network operator.

If the client device is allowed to have network access, the process proceeds to block 1908, and a determination is optionally made as to whether the requested URL is blacklisted (e.g., by comparing the requested URL with a list of blacklisted URLs, and if there is a match, a determination is made that the URL is blacklisted). If a determination is made that the URL is blacklisted, the user is so notified as similarly discussed above.

If the URL is not blacklisted, the process optionally proceeds to state 1910, and a determination is optionally made as to whether the requested URL is whitelisted (e.g., by comparing the requested URL with a list of whitelisted URLs, and if there is a match, a determination is made that the URL is whitelisted). If a determination is made that the URL is not whitelisted, the user is so notified as similarly discussed above.

If the URL is whitelisted, the process proceeds to block 1912, and a determination is optionally made as to whether there is a cache enabled indication. At least partly in response to a determination that the cache is enabled, a determination is made as to whether the content corresponding to the requested URL is already cached on the client device, and if so, the cache is caused to service the content for display on the client device.

If the cache is not enabled or if the requested content is not in the cache, the process proceeds to block 1914, and a determination is optionally made as to whether the URL rewrite process is to be performed. If there is an indication that the URL rewrite process is to be skipped, the client device browser is redirected to the requested URL without the URL being rewritten.

If there is not an indication that the URL rewrite process is to be skipped, the process proceeds to block 1916, and a determination is made as to whether the requested URL is in a non-processing list. In response to determining that the URL is in a non-processing list, the corresponding content is provided without URL rewrite processing. Thus, the URL may be examined, but is passed through the URL rewrite engine without modification.

If it is determined that the URL is not on a non-processing list, the process proceeds to block 1918, and a determination is made as to whether HTTP Error 304 is enabled. An HTTP Error 304 indicates that the resource for the requested URL has not changed since last accessed or cached. By providing an HTTP Error 304, the URL rewrite engine forces the client device to access the content from local cache, if the content is in the client device's local cache. However, the URL rewrite device may provide new headers (e.g., containing introductory content and/or a set of navigational links) and/or when the page is executed and requests are made for advertisements, the URL rewrite engine can provide advertisements from a source different than those requested by links in the page. For example, once the page (or other content) is loaded and the corresponding JavaScript is executed, resulting content requests are passed to the URL rewrite engine, which can intercept the requests and change the requested content (e.g., advertisements) as desired.

At block 1920, a determination is made as to whether a URL rewrite (e.g., for a reference embedded in the requested content corresponding to the URL received at block 1902) is to be performed. If a determination is made that the URL rewrite is not to be performed, then the output is provided to the requesting client, without processing the content of the resource. If a determination is made as to whether a URL rewrite is to be performed, the process proceeds to block 1922. For example, the URL rewrite engine may include a list (in the form of a table, flags, or otherwise) of URLs for a given website indicating which URLs are to be rewritten and/or which URLs are not to be rewritten.

At block 1922, the URL rewrite engine may optionally process the entire resource. However, if a reference (e.g., a link) is associated with a non-rewrite indication (e.g., a flag indicating the reference is not to be rewritten), then URL rewrite engine may skip rewriting that particular reference.

For references (e.g., URLs) that are to be rewritten, the URL rewrite engine rewrites the URL and applies the appropriate scheme/protocol specified by the requesting device (e.g., HTTP, HTTPS, FTP, FTPS, SFTP, Auto, etc.). The URL rewrite engine will apply rules to replace text in accordance with a “replace text” configuration of the URL rewrite engine. For example, text in a URL request may be modified or replaced to reduce errors (e.g., acme.com/finance may be replaced with a more reliable format, such as finance.acme.com). The URL rewrite engine may also record transaction information in a log (e.g., a log of requested URLs, denied URLs, error logs, database logs, etc.) and report the logged information to one or more specified destinations.

The RESTS may include or provide some or all of the following optional features:
1. The system may execute on one or more nodes connected to a network that conditionally transforms reference(s) and/or content (e.g., Internet references and/or content)
2. The references and content may include a compiled program, a runtime program, program script, HTML or SGML content, and/or other content, such as content that may invoke action or rendering on a computing device.
3. The system may include a registration database
4. The system may permit advertisers and publishers to register (e.g., provide contact information, billing/payment information, identification information, etc.) with registration records stored in the registration database
5. The system may permit network operators or Internet access providers to register, with registration records stored in the registration database
6. The system may allow network operators or Internet access providers to configure/specify permission rules (e.g., to control access to their network, to references, to content, etc.)
7. The system may substitute network references or content (e.g., with other/transformed network references or content)
8. The system may substitute resolved network objects (e.g., with other/transformed network objects)
9. The system may substitute cached objects (e.g., with other/transformed cached objects)
10. The rules may be used to manage permission access
11. The rules may be used to enable specialized routing
12. The rules may be used to manage object caching
13. The rules may be used to substitute objects
14. The rules may be used to substitute cached objects
15. The references may be compared to the rules for conditional reference transformation
16. The references may be compared to the rules to permit access
17. The system may store permission records
18. The system may include reports or interfaces for publisher to audit permission records
19. The system may include a report generator to generate reports and/or may provide interfaces for network operators or Internet access providers to audit access records
20. The system may include a database for logging and reporting requested, granted and denied access transactions
21. The system may be used to record and report fees granted access
22. The transactions may be used to collect access fees
23. The system may be used to substitute preferred content for content that was denied
24. The system may generate and/or communicate status and error messages (e.g., to content publishers)

Certain embodiments may be implemented via hardware, software stored on media, or a combination of hardware and software. For example, certain embodiments may include software/program instructions/modules stored on tangible, non-transitory computer-readable medium (e.g., magnetic memory/discs, optical memory/discs, RAM, ROM, FLASH memory, other semiconductor memory, etc.), accessible by one or more computing devices configured to execute the software (e.g., servers or other computing device including one or more processors, wired and/or wireless network interfaces (e.g., cellular, Wi-Fi, Bluetooth, T1, DSL, cable, optical, or other interface(s) which may be coupled to the Internet), content databases, customer account databases, etc.). Data stores (e.g., databases) may be used to store some or all of the information discussed herein in memory.

By way of example, a given computing device may optionally include user interface devices, such as some or all of the following: one or more displays, keyboards, touch screens, speakers, microphones, mice, track balls, touch pads, tilt sensors, accelerometers, biometric sensors (e.g., fingerprint or face recognition sensors for authenticating a user) printers, etc. The computing device may optionally include a media read/write device, such as a CD, DVD, Blu-ray, tape, magnetic disc, semiconductor memory, or other optical, magnetic, and/or solid state media device. A computing device, such as a user terminal, may be in the form of a general purpose computer, a personal computer, a laptop, a tablet computer, a mobile or stationary telephone, an interactive television, a set top box coupled to a display, etc. Certain embodiments may be able to conduct hundreds (or more) of transactions and processes described herein within a second.

While certain embodiments may be illustrated or discussed as having certain example components, additional, fewer, or different components may be used. Process described as being performed by a given system may be performed by a user terminal or other system or systems. Processes described as being performed by a user terminal may be performed by another system. Data described as being accessed from a given source may be stored by and accessed from other sources. Transmissions described herein may be via a wired and/or wireless network or other communications link. Further, with respect to the processes discussed herein, various states may be performed in a different order, not all states are required to be reached, and fewer, additional, or different states may be utilized.

User interfaces described herein are optionally presented (and user instructions may be received) via a user computing device using a browser, other network resource viewer, or otherwise. For example, the user interfaces may be presented (and user optionally instructions received) via an application (sometimes referred to as an “app”) installed on the user's mobile phone, laptop, pad, desktop, television, set top box, phone, or other terminal. Various features described or illustrated as being present in different embodiments or user interfaces may be combined into the same embodiment or user interface. While reference may be made to webpages, other types of electronic documents (including those not based on HTML) may be used. While reference may be made to websites, other network resources may be used.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y or Z,” unless specifically stated otherwise, is otherwise understood with the context as used in general to present that an item, term, etc., may be either X, Y or Z, or any combination thereof (e.g., X, Y and/or Z). Thus, such disjunctive language is not generally intended to, and should not, imply that certain embodiments require at least one of X, at least one of Y or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Various aspects and advantages of the embodiments have been described where appropriate. It is to be understood that not necessarily all such aspects or advantages may be achieved in accordance with any particular embodiment. Thus, for example, it should be recognized that the various embodiments may be carried out in a manner that achieves or optimizes one advantage or group of advantages as taught herein without necessarily achieving other aspects or advantages as may be taught or suggested herein. Further, embodiments may include several novel features, no single one of which is solely responsible for the embodiment's desirable attributes or which is essential to practicing the systems, devices, methods, and techniques described herein. In addition, various features of different embodiments may be combined to form still further embodiments. For example, aspects found in different user interfaces may be combined to form still further user interface.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above.

What is claimed is:

1. A computer-implemented method of controlling network access, the method comprising:
receiving at a URL rewrite engine comprising hardware a content request from a client device coupled to a local network;
accessing, by the URL rewrite engine, business rules, the business rules comprising a combination of meta rules and content rules;
applying, by the URL rewrite engine, the business rules to the request or the requested content, or both the request and the requested content, to determine how the content request, the content, or both the content request and the content, are to be processed; and
based at least in part on the application of the business rules, rewriting the request, denying the request, or modifying the requested content, by the URL rewrite engine.

2. The method as defined in claim 1, wherein the meta rules comprise a non-processing rule with respect to at least one URL.

3. The method as defined in claim 1, wherein the meta rules comprise a URL modification rule with respect to at least one URL.

4. The method as defined in claim 1, wherein the meta rules comprise a skip-proces sing rule with respect to at least one request.

5. The method as defined in claim 1, wherein the meta rules comprise a rule specifying that requests from a first IP address are authorized to access the local network.

6. The method as defined in claim 1, wherein the meta rules comprise a rule specifying what schema is to be used for at least a first communication with the client device.

7. The method as defined in claim 1, wherein the meta rules comprise a rule specifying a condition for cookie modification.

8. The method as defined in claim 1, wherein the meta rules comprise a rule specifying a condition for header modification, addition, or deletion.

9. The method as defined in claim 1, wherein the meta rules comprise a rule specifying a condition for code modification, addition, or deletion in content being provided to the client device.

10. The method as defined in claim 1, wherein the meta rules comprise a rule specifying a condition for turning on or off a content cache.

11. The method as defined in claim 1, wherein the content rules comprise a rule specifying a first type of content processing based at least in part on code included in the content.

12. The method as defined in claim 1, wherein the content rules comprise a rule specifying a first type of processing based at least in part on a URL included in the request.

13. The method as defined in claim 1, wherein the content rules comprise a rule specifying a first type of content processing based at least in part on a location of the client device.

14. The method as defined in claim 1, wherein the client device does not need to be specifically configured to access the URL rewrite engine.

15. The method as defined in claim 1, wherein the client device may access at least one resource associated with a corresponding requested URL without the URL being forward to the resource by the URL rewrite engine.

16. The method as defined in claim 1, wherein the URL rewrite engine hosts webpages corresponding to a domain or subdomain of an external resource which can be accessed by the client device using a URL for the external resource.

17. The method as defined in claim 1, wherein the URL rewrite engine is configured to rewrite at least one requested URL so that the URL cannot be resolved by an external domain name server (DNS).

18. A system comprising:
a data store configured to at least store computer-executable instructions; and
a hardware processor in communication with the data store, the hardware processor configured to execute the computer-executable instructions to at least:
receiving a content request from a client device coupled to a local network;
accessing a first set of rules, the first set of rules comprising a combination of meta rules and content rules;
applying the first set of rules to the request or the requested content, or both the request and the requested content, to determine how the content request, the content, or both the content request and the content, are to be processed; and
based at least in part on the application of the first set of rules, modifying the request, denying the request, or modifying the requested content.

19. The system as defined in claim 17, wherein the meta rules comprise a non-processing rule with respect to at least one URL.

20. The system as defined in claim 17, wherein the meta rules comprise a URL modification rule with respect to at least one URL.

21. The system as defined in claim 17, wherein the meta rules comprise a skip-processing rule with respect to at least one request.

22. The system as defined in claim 17, wherein the meta rules comprise a rule specifying that requests from a first IP address are authorized to access the local network.

23. The system as defined in claim 17, wherein the meta rules comprise a rule specifying what schema is to be used for at least a first communication with the client device.

24. The system as defined in claim 17, wherein the meta rules comprise a rule specifying a condition for cookie modification.

25. The system as defined in claim 17, wherein the meta rules comprise a rule specifying a condition for header modification, addition, or deletion.

26. The system as defined in claim 17, wherein the meta rules comprise a rule specifying a condition for code modification, addition, or deletion in content being provided to the client device.

27. The system as defined in claim 17, wherein the meta rules comprise a rule specifying a condition for turning on or off a content cache.

28. The system as defined in claim 17, wherein the content rules comprise a rule specifying a first type of content processing based at least in part on code included in the content.

29. The system as defined in claim 17, wherein the content rules comprise a rule specifying a first type of processing based at least in part on a URL included in the request.

30. The system as defined in claim 17, wherein the content rules comprise a rule specifying a first type of content processing based at least in part on a location of the client device.

31. The system as defined in claim 17, wherein the client device does not need to be specifically configured to access the URL rewrite engine.

32. The system as defined in claim 17, wherein the client device may access at least one resource associated with a corresponding requested URL without the URL being forward to the resource by the URL rewrite engine.

33. The system as defined in claim 17, wherein the URL rewrite engine hosts webpages corresponding to a domain or subdomain of an external resource which can be accessed by the client device using a URL for the external resource.

34. A non-transitory computer-readable storage medium storing computer-executable instructions that when executed by a computing device cause the computing device to perform operations comprising:
receiving a content request from a client device coupled to a local network;
accessing a first set of rules, the first set of rules comprising a combination of meta rules and content rules;
applying the first set of rules to the request or the requested content, or both the request and the requested content, to determine how the content request, the content, or both the content request and the content, are to be processed; and
based at least in part on the application of the first set of rules, modifying the request, denying the request, or modifying the requested content.
